(19) United States
(12) Patent Application Publication
(10) Pub. No.: US 2020/0293133 A1
(43) Pub. Date: Sep. 17, 2020

(54) INFORMATION PROCESSING APPARATUS, INFORMATION PROCESSING METHOD, AND RECORDING MEDIUM

(71) Applicant: Ochanomizu University, Tokyo (JP)

(72) Inventors: Itiro SIIO, Tokyo (JP); Kaori IKEMATSU, Tokyo (JP)

(21) Appl. No.: 16/892,639

(22) Filed: Jun. 4, 2020

Related U.S. Application Data
(63) Continuation of application No. PCT/JP2018/042941, filed on Nov. 21, 2018.

(30) Foreign Application Priority Data
Dec. 5, 2017 (JP) 2017-233082

(51) Int. Cl. G06F 3/045; G06F 3/044; G06F 3/033

(52) U.S. Cl. CPC G06F 3/045; G06F 2203/04106; G06F 3/033; G06F 3/0446

(57) ABSTRACT

An information processing apparatus includes a capacitive touch surface configured to receive an operation; an auxiliary object provided in contact with the touch surface and whose resistance value is changed; a memory; and a processor coupled to the memory and configured to obtain an electrical characteristic relating to the resistance value detected by the touch surface, and display data based on the electrical characteristic.

### CROSS-REFERENCE TO RELATED APPLICATIONS

This application is a continuation of International Application No. PCT/JP2018/042941, filed on Nov. 21, 2018 and designating the U.S., which claims priority to Japanese Patent Application No. 2017-233082 filed on Dec. 5, 2017. The contents of these applications are incorporated herein by reference in their entirety.

### BACKGROUND OF THE INVENTION

### 1. Field of the Invention

The disclosures herein relate to an information processing apparatus, an information processing method, and a recording medium.

### 2. Description of the Related Art

Information processing apparatuses that receive users' touch operations on resistive or capacitive input devices are conventionally known.

For example, in such a capacitive touch screen, there is known a method in which an object manufactured by a 3D printer is placed on the capacitive touch screen, capacitance is changed by bending or pressing the object, and an image on a display is varied in accordance with changes in the capacitance (see Non-Patent Document 1, for example).

However, the related-art method is a method for controlling input operations by sensing capacitance on the capacitive touch surface. With this method, it is difficult to change the capacitance component in impedance for certain user actions.

### RELATED-ART DOCUMENTS

### Non-Patent Documents

Non-patent document 1: M. Schmitz, J. Steimle, J. Huber, N. Dezfuli, and M. Muhlhauser. Flexibles: Deformation-Aware 3D-Printed Tangibles for Capacitive Touchscreens. In Proceedings of CHI '17, pp. 1001-1014, 2017.

### SUMMARY OF THE INVENTION

It is a general object of the described embodiments to enhance indirect touch interaction for capacitive touch surfaces by using resistance.

According to an aspect of an embodiment, an information processing apparatus includes a capacitive touch surface configured to receive an operation; an auxiliary object provided in contact with the touch surface and whose resistance value is changed; a memory; and a processor coupled to the memory and configured to obtain an electrical characteristic relating to the resistance value detected by the touch surface, and display data based on the electrical characteristic.

According to an aspect of an embodiment, an information processing method performed by an information processing apparatus is provided. The information processing apparatus includes a capacitive touch surface configured to receive an operation; and an auxiliary object provided in contact with the touch surface and whose resistance value is changed. The method includes obtaining an electrical characteristic relating to the resistance value detected by the touch surface, and displaying data based on the electrical characteristic.

According to an aspect of an embodiment, a non-transitory recording medium storing a program for causing a computer to execute an information processing method is provided. The computer includes a capacitive touch surface configured to receive an operation; and an auxiliary object provided in contact with the touch surface and whose resistance value is changed. The method includes obtaining an electrical characteristic relating to the resistance value detected by the touch surface, and displaying data based on the electrical characteristic.

### BRIEF DESCRIPTION OF THE DRAWINGS

Other objects and further features of the present invention will be apparent from the following detailed description when read in conjunction with the accompanying drawings, in which:

FIG. 1 is a schematic diagram illustrating an example of the overall configuration of an information processing apparatus according to a first embodiment;

FIG. 2 is a block diagram illustrating an example of the hardware configuration of the information processing apparatus according to the first embodiment;

FIG. 3 is an external view of the information processing apparatus according to the first embodiment;

FIGS. 4A and 4B are diagrams illustrating examples of the operation and display of the information processing apparatus according to the first embodiment;

FIG. 5 is an external view of an information processing apparatus according to a second embodiment;

FIG. 6 is a diagram illustrating an example of the operation and display of the information processing apparatus according to the second embodiment;

FIG. 7 is an external view of an information processing apparatus according to a third embodiment;

FIGS. 8A and 8B are diagrams illustrating examples of the operation and display of the information processing apparatus according to the third embodiment;

FIG. 9 is an external view of an information processing apparatus according to a fourth embodiment;

FIGS. 10A through 100 are diagrams illustrating examples of the operation and display of the information processing apparatus according to the fourth embodiment;

FIG. 11 is an external view of an information processing apparatus according to a fifth embodiment;

FIGS. 12A through 12C are diagrams illustrating examples of the operation and display of the information processing apparatus according to the fifth embodiment;

FIG. 13 is an external view of an information processing apparatus according to a sixth embodiment;

FIG. 14 is a diagram illustrating an example of the operation and display of the information processing apparatus according to the sixth embodiment;

FIG. 15 is an external view of an information processing apparatus according to a seventh embodiment;

FIGS. 16A and 16B are diagrams (part 1) illustrating examples of the operation and display of the information processing apparatus according to the seventh embodiment;

FIGS. 17A and 17B are diagrams (part 2) illustrating examples of the operation and display of the information processing apparatus according to the seventh embodiment;

FIG. 18 is an external view of an information processing apparatus according to an eighth embodiment;

FIGS. 19A through 19D are diagrams illustrating examples of the operation and display of the information processing apparatus according to the eighth embodiment;

FIG. 20 is an external view of an information processing apparatus according to a ninth embodiment;

FIGS. 21A and 21B are diagrams illustrating examples of the operation and display of the information processing apparatus according to the ninth embodiment;

FIGS. 22A through 22C are diagrams illustrating examples of the operation and display of an information processing apparatus according to a tenth embodiment;

FIG. 23 is an external view of an information processing apparatus according to an eleventh embodiment;

FIGS. 24A and 24B are diagrams illustrating examples of the operation and display of the information processing apparatus according to the eleventh embodiment;

FIG. 25 is an external view of an information processing apparatus according to a twelfth embodiment;

FIG. 26 is a diagram illustrating an example of the operation and display of the information processing apparatus according to the twelfth embodiment;

FIG. 27 is an external view of an information processing apparatus according to a thirteenth embodiment;

FIGS. 28A and 28B are diagrams illustrating examples of the operation and display of the information processing apparatus according to the thirteenth embodiment;

FIGS. 29A through 29C are an external view of an information processing apparatus and circuit diagrams according to a fourteenth embodiment;

FIGS. 30A and 30B are diagrams illustrating examples of the operation and display of the information processing apparatus according to the fourteenth embodiment;

FIGS. 31A through 31C are an external view of an information processing apparatus and circuit diagrams according to a fifteenth embodiment;

FIG. 32 is a flowchart illustrating an example of the overall process; and

FIG. 33 is block diagram illustrating an example of the functional configuration of an information processing apparatus.

### DESCRIPTION OF THE EMBODIMENTS

According to one embodiment of the present invention, it is possible to enhance indirect touch interaction for capacitive touch surfaces by using resistance.

In the following, embodiments of the present invention will be described with reference to the accompanying drawings.

### First Embodiment

### <Example of Overall Configuration>

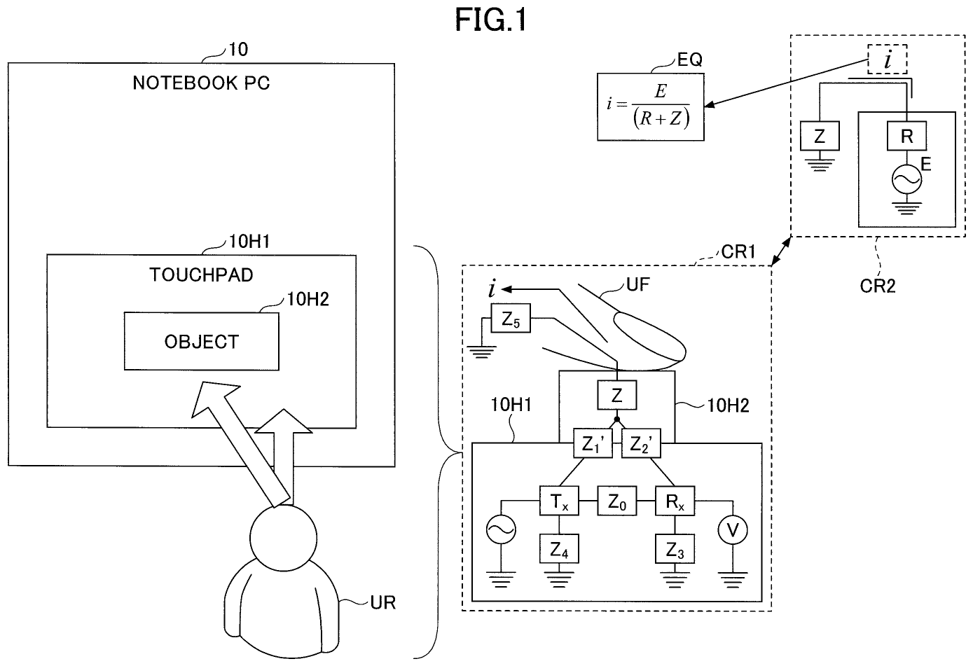

FIG. 1 is a schematic diagram illustrating an example of the overall configuration of an information processing apparatus according to a first embodiment. In the following example as illustrated in FIG. 1, an example in which an information processing apparatus is a notebook personal computer (PC) 10 will be described.

In the example illustrated in FIG. 1, the notebook PC 10 includes a touchpad 10H1, which is an example of a touch surface. In the following, an example in which the touch surface is the touchpad 10H1 will be described.

Further, as illustrated in FIG. 1, an object 10H2 is placed on the touchpad 10H1. The object 10H2 is placed such that a part of or the entirety of the object 10H2 is in contact with the touchpad 10H1. Details of the object 10H2 will be described later.

### <Example of Hardware Configuration of Information Processing Apparatus>

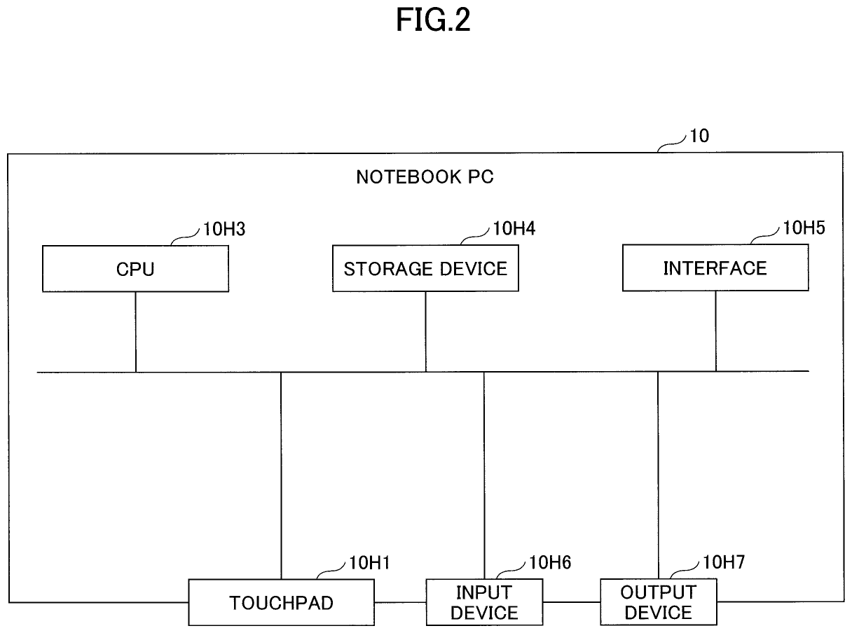

FIG. 2 is a block diagram illustrating an example of the hardware configuration of the information processing apparatus according to the first embodiment. As illustrated in FIG. 2, the hardware configuration of the notebook PC 10 includes a central processing unit (CPU) 10H3, a storage device 10H4, an interface 10H5, an input device 10H6, and an output device 10H7.

The CPU 10H3 is an example of an arithmetic device or a controller.

The storage device 10H4 may be a main storage device such as a memory, or may be an auxiliary storage device such as a hard disk drive (HDD).

The interface 10H5 may be a connector that connects an external device to the notebook PC 10. For example, the notebook PC 10 inputs and outputs data by sending and receiving signals to and from an external device via a network or a cable.

The input device 10H6 is a device that receives an operation performed by a user UR. For example, the input device 10H6 may be a keyboard.

The output device 10H7 is a device that indicates processing results to the user UR. For example, the output device 10H7 may be a display.

Note that the hardware configuration of the notebook PC 10 is not limited to the illustrated hardware configuration. That is, the notebook PC 10 may further include an arithmetic device, a storage device, or a controller. In addition, the notebook PC 10 may be configured by two or more apparatuses.

The touchpad 10H1 may be a peripheral device connected by the interface 10H5. In this case, a driver for the touchpad 10H1 is installed on the notebook PC 10, and the notebook PC 10 receives an operation performed on the peripheral device, similar to the touchpad 10H1.

Further, the touchpad 10H1 may be a pointing device such as a trackpad or a touch panel.

For example, the touchpad 10H1 has a structure in which transparent linear electrodes are arranged in a grid pattern.

### <Example of Placement of Object>

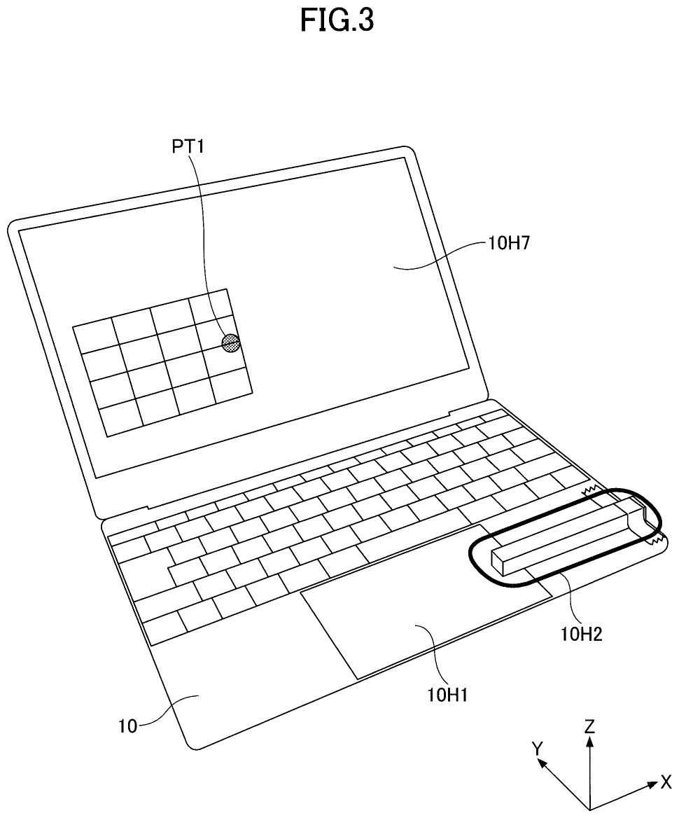

FIG. 3 is an external view of the information processing apparatus according to the first embodiment. As illustrated in FIG. 3, in the first embodiment, the object 10H2 is placed such that a part of the object 10H2 is in contact with the touchpad 10H1.

For example, the object 10H2 is formed of a material including an electrically conductive material. Specifically, the object 10H2 is formed of a material such as a conductive ABS (a copolymer of acrylonitrile, butadiene, and styrene) filament or a non-conductive ABS filament. Note that the conductive ABS filament may be, for example, a material having a sheet resistance of approximately 103Ω (ohm) to approximately 105Ω.

For example, the object 10H2 may be manufactured by a fused deposition modeling 3D printer. Note that the object 10H2 may be formed of a material other than the above-mentioned materials, and may be manufactured by a method other than the above-mentioned manufacturing method.

In the following, an example of a user interface (UI) will be described. In this example, when a grounded electrical conductor such as a body part of the user UR touches the object 10H2, the position of a pointer PT indicated on the output device 10H7 is displayed in accordance with the touch position of the grounded electrical conductor. Note that the UI does not necessarily have the illustrated format. In the following example, the body part of the user UR is the user's “fingertip UF”.

The grounded electrical conductor is not required to be a human body. The grounded electrical conductor may be any object, as long as the object is electrically grounded and is electrically conductive such that a current flows to the ground, as illustrated in a circuit diagram CR1. For example, the grounded electrical conductor may be a sensor such as an optical sensor whose resistance value is changed in accordance with the amount of light. In this case, one end of the sensor is connected to the touch surface, and the other end of the sensor is grounded.

### <Examples of Operation and Display>

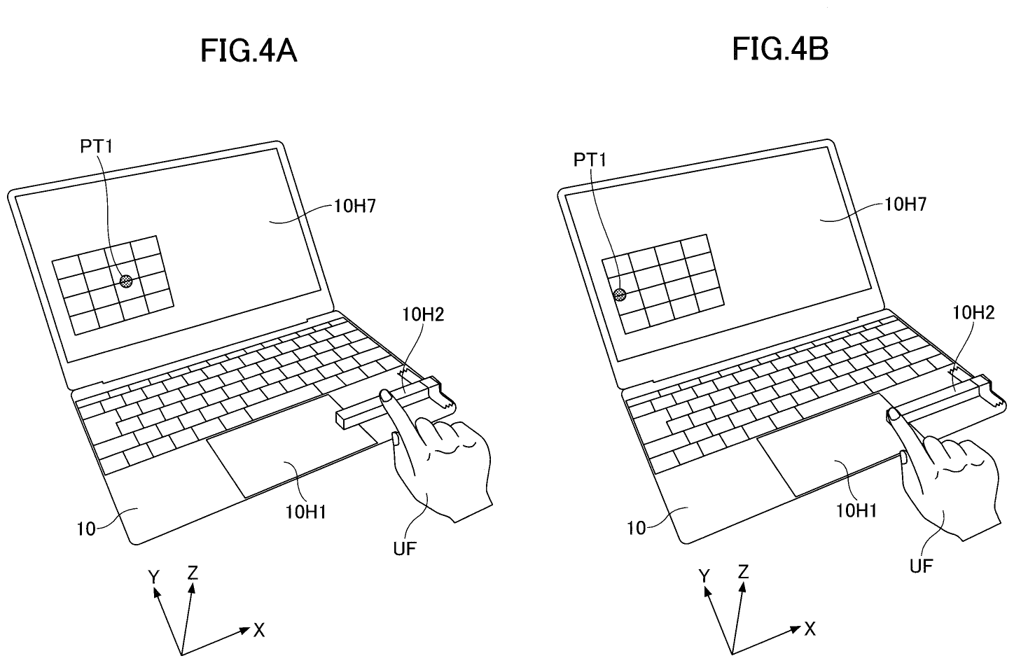

FIGS. 4A and 4B are diagrams illustrating examples of the operation and display of the information processing apparatus according to the first embodiment. First, as illustrated in FIG. 4A, with the fingertip UF, the user UR touches a portion of the object 10H2 placed as illustrated in FIG. 3. That is, the user UR brings the fingertip UF into contact with approximately a center portion of the object 10H2. When such an operation is performed, the notebook PC 10 displays the pointer PT1 near the center, as illustrated in FIG. 4A.

Further, as illustrated in FIG. 4B, the user UR brings the fingertip UF into contact with the left end of the object 10H2. When such an operation is performed, the notebook PC 10 displays the pointer PT1 near the left end, as illustrated in FIG. 4B. Accordingly, the object 10H2 included in the notebook PC 10 functions as what is known as a touch bar.

As described above, because the notebook PC 10 includes the object 10H2, even when the touch position of the fingertip UF is not the touchpad 10H1, the notebook PC 10 can move and display the pointer PT1 in accordance with the touch position of the fingertip UF. That is, the notebook PC 10 can receive the user's operation not only on the touchpad 10H1, but also on the object 10H2, thus extending the range in which the user's operation can be received.

Accordingly, in response to receiving the user's operation for bringing the fingertip UF into contact with a given point of the object 10H2, which functions as a touch bar, the notebook PC 10 identifies the touch position of the fingertip UF based on electrical characteristics such as a current value “i”. This enables one-dimensional parameter operations (such as moving the position of pointer PT1 in the X-axis direction, as illustrated in FIGS. 4A and 4B)

### <Example of Display Based on Electrical Characteristics>

When a human body touches the capacitive touch surface, a portion of the electrical current, flowing between electrodes, flows to the ground through the human body. Therefore, the current flowing between the electrodes is decreased, as compared to when the human body does not touch the touch surface. The notebook PC 10 can detect such a decrease in the current.

Further, when the object 10H2, which is an object other than the human body, is placed between the human body and the touch surface, a portion of the current, flowing between the electrodes, flows to the ground through the human body and the object 10H2, and the current flowing between the electrodes is decreased.

More specifically, a decrease in current flowing between electrodes can be detected based on a change in a current value “i” illustrated in FIG. 1. The current value “i” can be obtained from an application programming interface (API) of an operating system (OS) that is preliminarily installed on the notebook PC 10. Note that even if the notebook PC 10 does not integrally include the touchpad 10H1, the current value “i” can be obtained from the OS by installing a driver for the touchpad 10H1. Further, a value directly representing the current value “i” is not necessarily obtained from the OS, and a parameter proportional to the current value “i” may be obtained from the OS.

Further, electrical characteristics, obtained when an operation as described above is performed on the object 10H2, can be represented by the circuit diagram CR1 as illustrated in FIG. 1. Specifically, the circuit diagram CR1 is a diagram that schematically illustrates electrical characteristics between electrodes in the touchpad 10H1. In this example, it is assumed that a high-frequency signal is transmitted from a transmission electrode “Tx” to a reception electrode “Rx”. Further, the transmission electrode “Tx” is grounded via an impedance component “Z4”, and the reception electrode “Rx” is grounded via an impedance component “Z3”.

In addition, it is assumed that the transmission electrode “Tx” and the reception electrode “Rx” are connected via an impedance component “Z0”. When the fingertip UF does not touch the touchpad 10H1, only the impedance component “Z0” is present between the transmission electrode “Tx” and the reception electrode “Rx”. Conversely, when the human body touches the object 10H2, a portion of the current flowing between the transmission electrode “Tx” and the reception electrode “Rx” flows to the ground via two contact points, impedance components “Z1′” and “Z2′”, and further via an impedance component “Z5”.

Accordingly, by receiving a signal detected at the reception electrode “Rx”, the notebook PC 10 can determine whether the fingertip UF touches the object 10H2, based on a change in electrical characteristics obtained when only the impedance component “Z0” is present between the transmission electrode “Tx” and the reception electrode “Rx”.

Further, a circuit equivalent to the circuit diagram CR1 may be represented by an equivalent circuit CR2, based on Thevenin's theorem. As indicated by the equivalent circuit CR2, the circuit diagram CR1 can be represented by a simple equivalent circuit in which internal resistance R and electromotive force E are connected in series, to which impedance Z is connected.

Accordingly, based on the equivalent circuit CR2, a current value “i” can be expressed by electromotive force “E”, an internal resistance “R”, and impedance “Z”, as in an equation EQ that indicates electrical characteristics.

When the touch position of the fingertip UF changes, the current path changes and the resistance value changes. As a result, the impedance “Z” changes in the equation EQ. Conversely, even when the touch position of the fingertip UF changes, the electromotive force “E” and the internal resistance “R” are approximately constant. Therefore, the current value “I” changes approximately in accordance with the impedance “Z”. Accordingly, the notebook PC 10 can determine the touch position of the fingertip UF by obtaining a current value “i”.

The object 10H2 may be placed at any position, may be formed of any material, and may have any shape and size, as long as the resistance of the object 10H2 is changed in accordance with changes in the touch position, and the current value “i” is changed.

### Second Embodiment

The overall configuration and the hardware configuration of an information processing apparatus according to a second embodiment are similar to those of the first embodiment. In the following, differences from the first embodiment will be mainly described, and a duplicate description will be omitted.

An object 10H2 of the second embodiment differs from the object 10H2 of the first embodiment.

### <Example of Placement of Object>

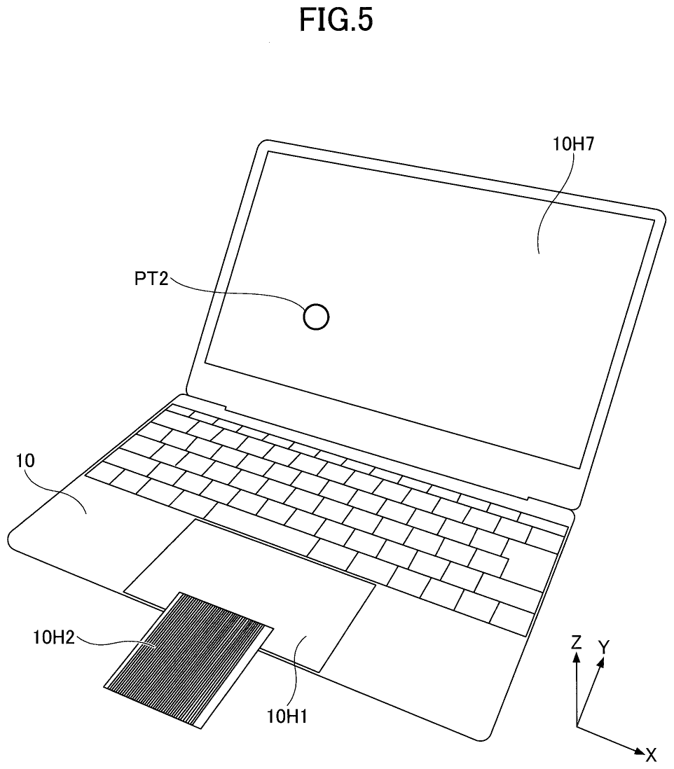

FIG. 5 is an external view of the information processing apparatus according to the second embodiment. As illustrated in FIG. 5, in the second embodiment, the object 10H2 is placed such that a part of the object 10H2 is in contact with the touchpad 10H1.

For example, the object 10H2 may be manufactured by printing a plurality of lines on dedicated paper with an electrically conductive material such as a silver nanoparticle ink. Specifically, in the example illustrated in FIG. 5, the striped pattern is printed on the object 10H2 with a silver nanoparticle ink.

### <Example of Operation and Display>

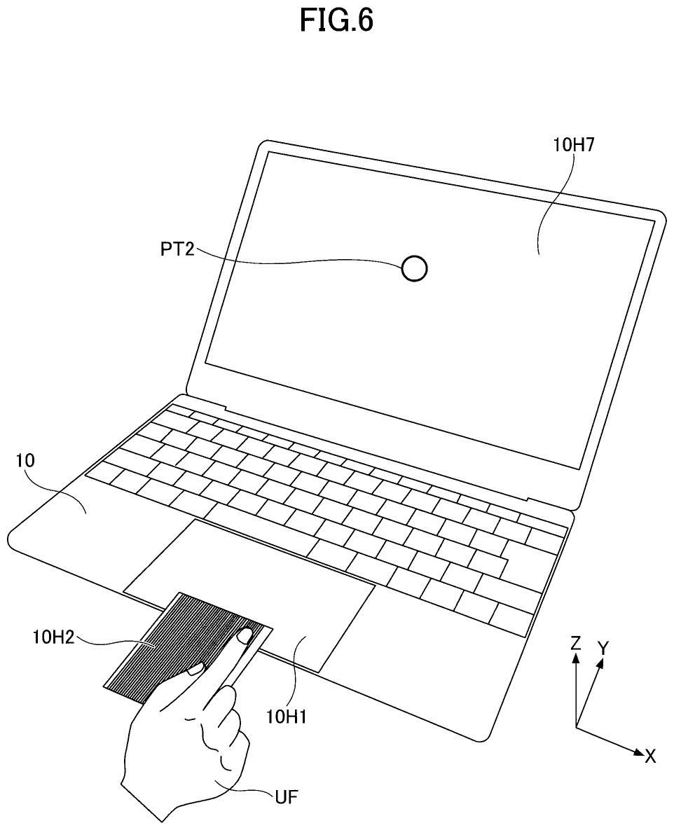

FIG. 6 is a diagram illustrating an example of the operation and display of the information processing apparatus according to the second embodiment. For example, as illustrated in FIG. 6, the user UR moves a pointer PT2 on the object 10H2 with the fingertip UF, as in the case of the touchpad 10H1.

In this manner, in the second embodiment, the user UR can perform a two-dimensional operation on the object 10H2 (in the X-Y plane, in the example illustrated in FIG. 6).

Even when such an operation is performed, the notebook PC 10 can identify the touch position of the fingertip UF by obtaining a current value “i”. Accordingly, the notebook PC 10 can change the display position of the pointer PT2, based on electrical characteristics such as a current value “i”. That is, with the object 10H2 illustrated in FIG. 6, it is possible to extend the range in which the notebook PC 10 can receive the user's operation.

### Third Embodiment

The overall configuration and the hardware configuration of an information processing apparatus according to a third embodiment are similar to those of the first embodiment. In the following, differences from the first embodiment will be mainly described, and a duplicate description will be omitted.

An object 10H2 of the third embodiment differs from the object 10H2 of the first embodiment.

### <Example of Placement of Object>

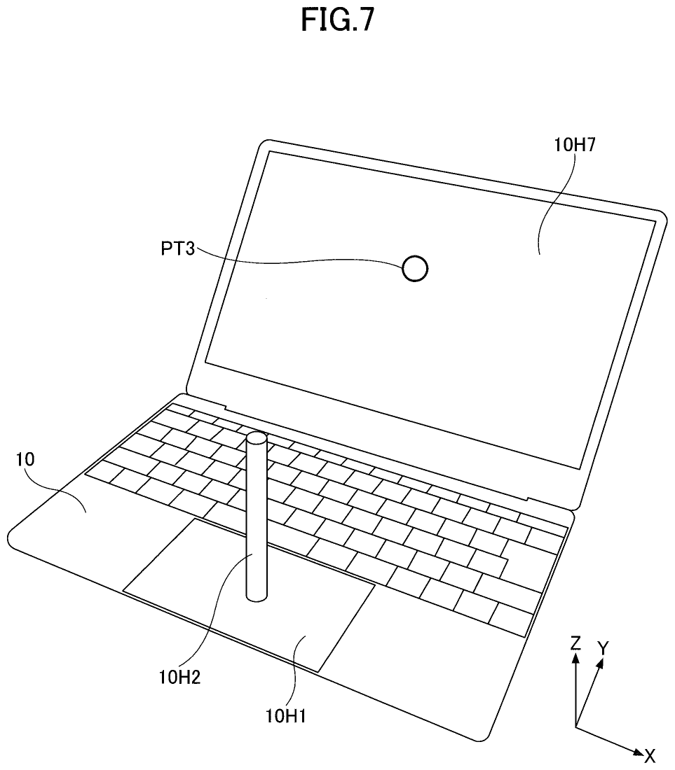

FIG. 7 is an external view of the information processing apparatus according to the third embodiment. As illustrated in FIG. 7, in the third embodiment, the object 10H2 is placed on the touchpad 10H1.

The object 10H2 in the third embodiment is formed of the same material as in the first embodiment, and is manufactured in the same manner as in the first embodiment. As illustrated in FIG. 7, the third embodiment differs from the first embodiment in that the object 10H2 extends in the vertical direction (in the Z-axis direction, in the example illustrated in FIG. 7).

### <Examples of Operation and Display>

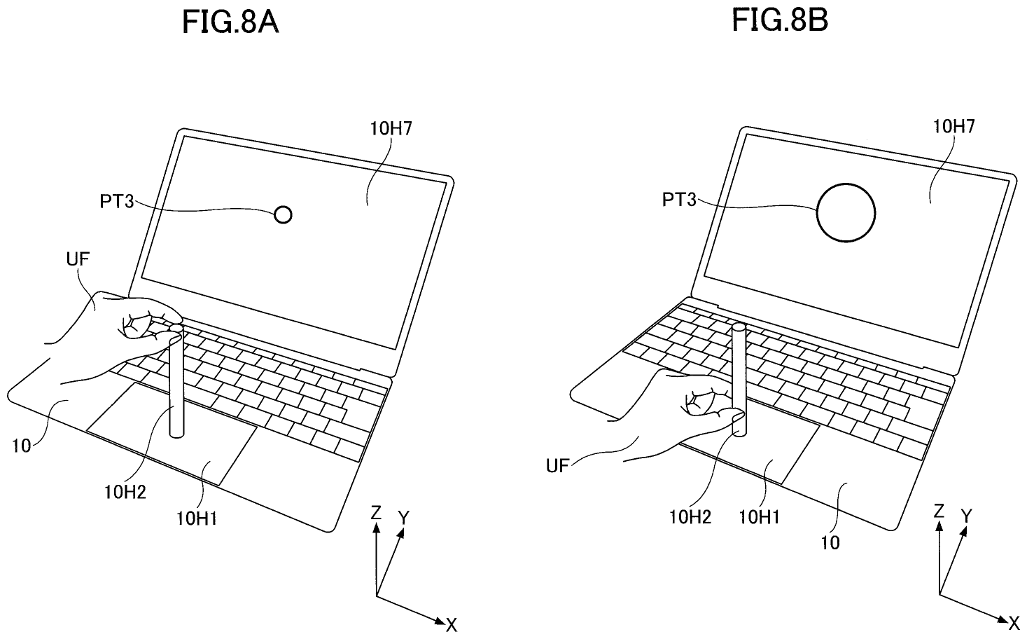

FIGS. 8A and 8B are diagrams illustrating examples of the operation and display of the information processing apparatus according to the third embodiment. For example, the user UR touches different positions in the vertical direction. Specifically, as illustrated in FIG. 8A, the user UR brings the fingertip UF into contact with an upper part of the object 10H2. Conversely, as illustrated in FIG. 8B, the user UR brings the fingertip UF into contact with a lower part of the object 10H2.

Even when such an operation is performed, the notebook PC 10 can identify the position where the fingertip UF touches the object 10H2, that is, the position in the vertical direction of the object 10H2, by obtaining a current value “i”

In the examples illustrated in FIGS. 8A and 8B, the notebook PC 10 scales up or down a pointer T3 in accordance with the identified touch position of the fingertip UF. Specifically, as illustrated in FIG. 8A, when the touch position is high, the notebook PC 10 reduces the size of the pointer T3 and display the pointer T3. That is, in the example illustrated in FIG. 8A, the notebook PC 10 displays the scaled-down pointer T3.

Conversely, as illustrated in FIG. 8B, when the touch position is low, the notebook PC 10 increases the size of the pointer T3 and displays the pointer T3. That is, in the example illustrated in FIG. 8B, the notebook PC 10 displays the scaled-up pointer T3.

As described above, the notebook PC 10 may identify the position in the vertical direction of the object 10H2 touched by the fingertip UF based on a current value “i”, and may receive what is known as a zoom operation.

### Fourth Embodiment

The overall configuration and the hardware configuration of an information processing apparatus according to a fourth embodiment are similar to those of the first embodiment. In the following, differences from the first embodiment will be mainly described, and a duplicate description will be omitted.

An object 10H2 of the fourth embodiment differs from the object 10H2 of the first embodiment.

### <Example of Placement of Object>

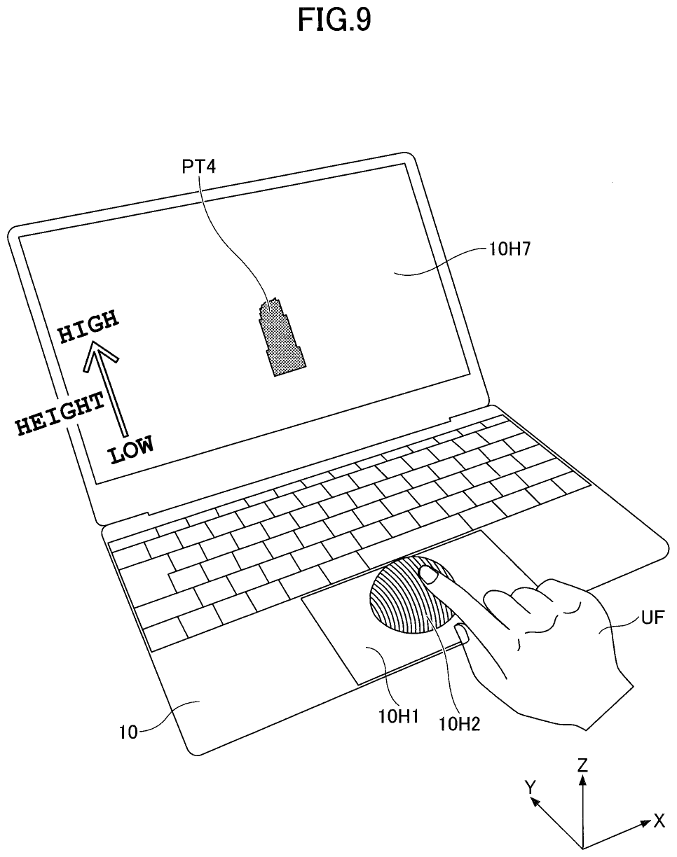

FIG. 9 is an external view of the information processing apparatus according to the fourth embodiment. As illustrated in FIG. 9, in the fourth embodiment, the object 10H2 is placed on the touchpad 10H1.

The object 10H2 in the fourth embodiment is formed of the same material as in the first embodiment, and is manufactured in the same manner as in the first embodiment. As illustrated in FIG. 9, the fourth embodiment differs from the first embodiment in that the object 10H2 protrudes in the vertical direction (in the Z-axis direction, in the example illustrated in FIG. 9).

### <Examples of Operation and Display>

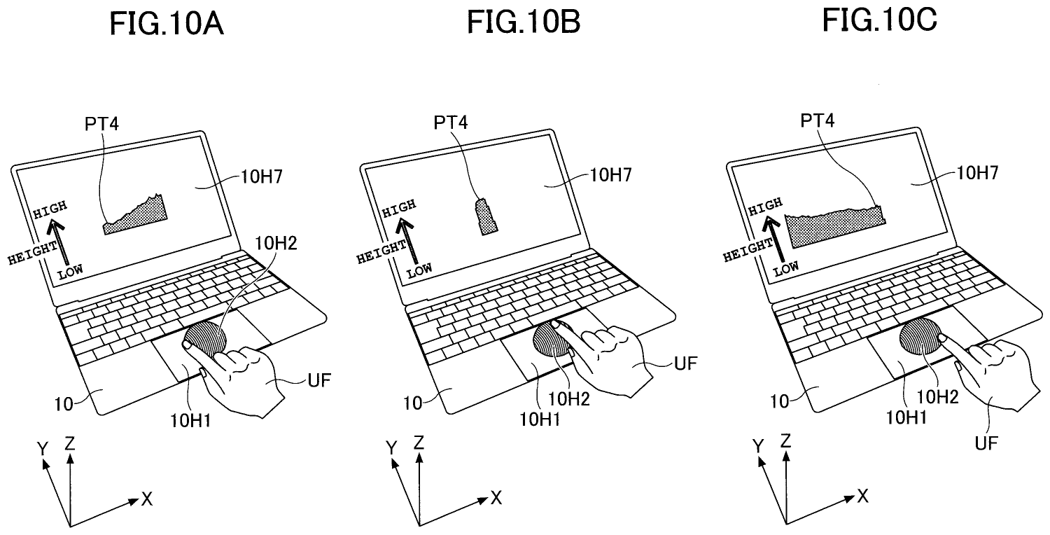

FIGS. 10A though 10C are diagrams illustrating examples of the operation and display of the information processing apparatus according to the fourth embodiment. As illustrated in FIG. 10A, the user UR brings the fingertip UF into contact with the left end of the object 10H2. As illustrated, the left end of the object 10H2 is low. Therefore, in the example illustrated in FIG. 10A, the position where the fingertip UF touches the object 10H2 is low.

Conversely, as illustrated in FIG. 10B, the user UR brings the fingertip UF into contact with the middle of the object 10H2. As illustrated, the middle of the object 10H2 is high (in the Z-axis direction in FIG. 10B). Therefore, in the example illustrated in FIG. 10B, the position where the fingertip UF touches the object 10H2 is high.

Further, as illustrated in FIG. 10C, the user UR brings the fingertip UF into contact with the right end of the object 10H2. As illustrated, the right end of the object 10H2 is low. Therefore, in the example illustrated in FIG. 10C, the position where the fingertip UF touches the object 10H2 is low.

Even when such an operation is performed, the notebook PC 10 can identify the position where the fingertip UF touches the object 10H2, that is, the position in the vertical direction of the object 10H2, by obtaining a current value “i”.

In addition, in the examples illustrated in FIGS. 10A through 10C, the notebook PC 10 displays height information with a pointer PT4, in accordance with the identified touched position. Specifically, as illustrated in FIG. 10A and FIG. 10C, when the touch position is low, the notebook PC 10 displays the pointer PT4 on the “low” side, as compared to FIG. 10B. Further, as illustrated in FIG. 10B, when the touch position is high, the notebook PC 10 displays the pointer PT4 on the “high” side, as compared to FIG. 10A and FIG. 10C.

As described above, the notebook PC 10 may identify the position in the vertical direction of the object 10H2 touched by the fingertip UF based on a current value “i”, and may receive an operation for changing an image in accordance with the height of the identified touch position.

### Fifth Embodiment

The overall configuration and the hardware configuration of an information processing apparatus according to a fifth embodiment are similar to those of the first embodiment. In the following, differences from the first embodiment will be mainly described, and a duplicate description will be omitted.

Objects 10H2 of the fifth embodiment differ from the object 10H2 of the first embodiment.

### <Example of Placement of Object>

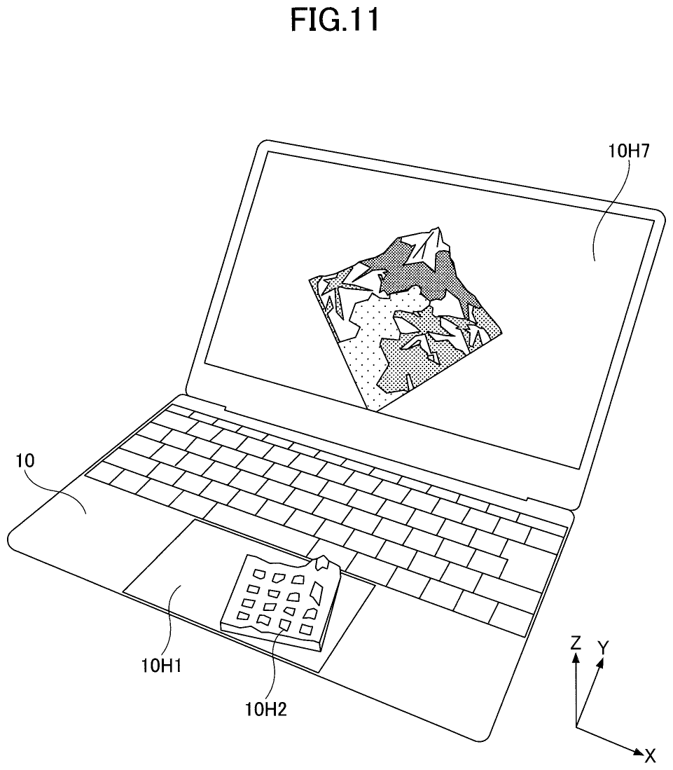

FIG. 11 is an external view of the information processing apparatus according to the fifth embodiment. As illustrated in FIG. 11, in the fifth embodiment, the plurality of objects 10H2 provided in a holder are placed on the touchpad 10H1.

The plurality of objects 10H2 in the fifth embodiment are formed of the same material as in the first embodiment, and are manufactured in the same manner as in the first embodiment. As illustrated in FIG. 11, the plurality of objects 10H2 have different heights (in the Z-axis direction, in the example illustrated in FIG. 9). In the fifth embodiment, the plurality of objects 10H2 are provided in a grid pattern in the holder and placed on the touchpad 10H1.

### <Examples of Operation and Display>

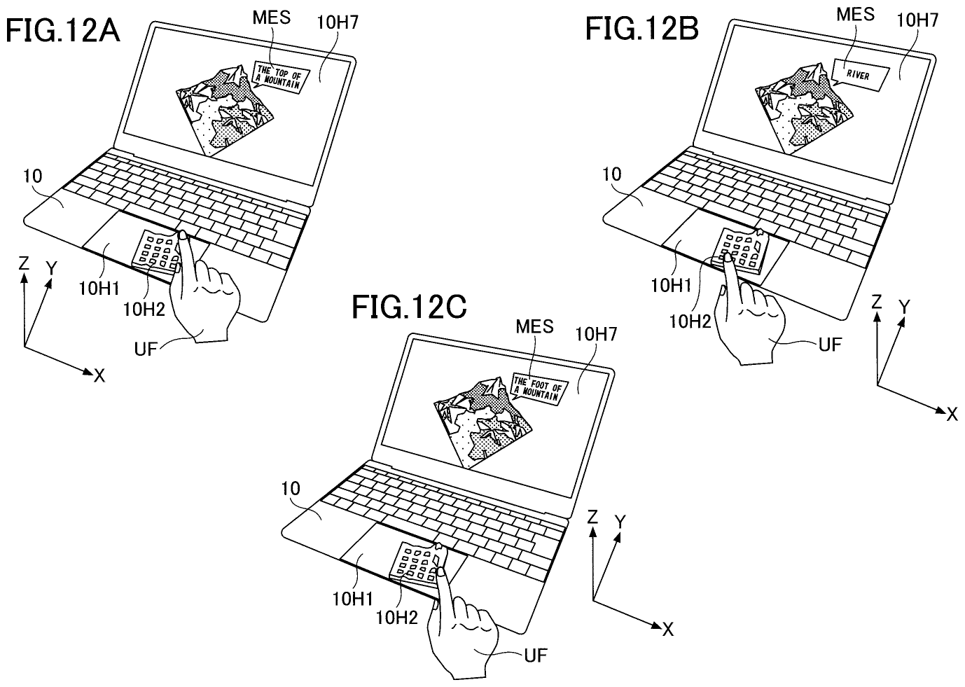

FIGS. 12A through 12C are diagrams illustrating examples of the operation and display of the information processing apparatus according to the fifth embodiment. For example, as illustrated in FIGS. 12A through 12C, the user UR touches different objects 10H2 of the plurality of objects 10H2.

The objects 10H2 have different resistance values in accordance with the lengths of the objects 10H2. Therefore, when the user UR touches the different objects 10H2, currents flowing through the fingertip UF differ. Accordingly, the notebook PC 10 can identify which object 10H2, of the plurality of objects 10H2, is touched by the fingertip UF by obtaining a current value “i”. In other words, the notebook PC 10 can identify not only two-dimensional coordinates (coordinates in the X-Y plane, in the example illustrated in FIGS. 12A through 12C), but also a coordinate in the vertical direction (in Z-axis direction, in the example illustrated in FIGS. 12A through 12C) of the touch position of the fingertip UF.

The notebook PC 10 displays a message (MES) in accordance with the touch position identified based on electrical characteristics such as a current value “i”. In the examples illustrated in FIGS. 12A through 12C, the plurality of objects 10H2 are used to display images representing landforms. When an object 10H2 corresponding to an image representing the “top of a mountain” is touched, the notebook PC 10 displays a message (MES) indicating “THE TOP OF A MOUNTAIN”, as illustrated in FIG. 12A. Similarly, when an object 10H2 corresponding to an image representing a “river” is touched, the notebook PC 10 displays a message (MES) indicating “RIVER”, as illustrated in FIG. 12B. Further, when an object 10H2 corresponding to an image representing the “foot of a mountain” is touched, the notebook PC 10 displays a message (MES) indicating “THE FOOT OF A MOUNTAIN”, as illustrated in FIG. 12C.

### Sixth Embodiment

The overall configuration and the hardware configuration of an information processing apparatus according to a sixth embodiment are similar to those of the first embodiment. In the following, differences from the first embodiment will be mainly described, and a duplicate description will be omitted.

An object 10H2 of the sixth embodiment differs from the object 10H2 of the first embodiment.

### <Example of Placement of Object>

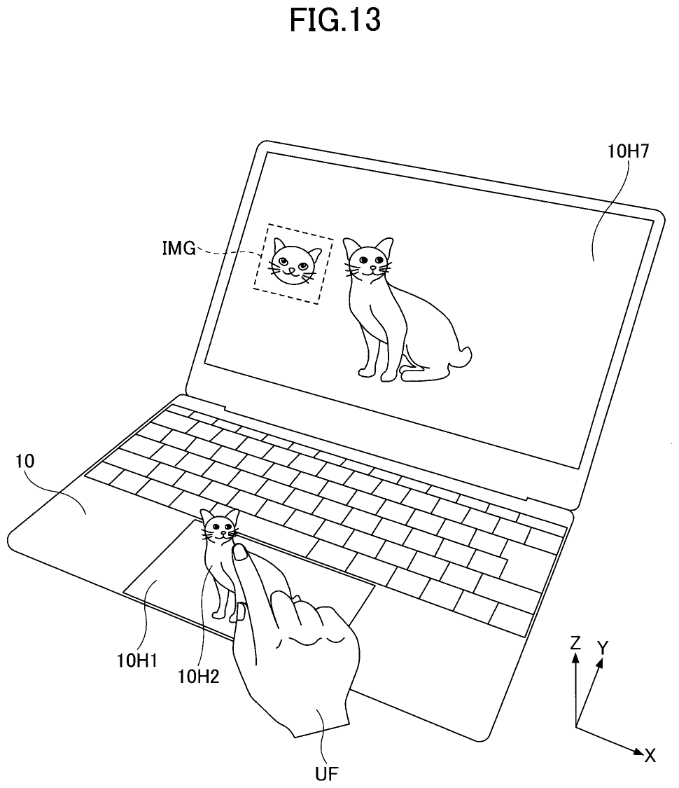

FIG. 13 is an external view of the information processing apparatus according to the sixth embodiment. As illustrated in FIG. 13, in the sixth embodiment, the object 10H2 is placed on the touchpad 10H1.

The object 10H2 in the sixth embodiment is formed of the same material as in the first embodiment, and is manufactured in the same manner as in the first embodiment. As illustrated in FIG. 13, The shape of the object 10H2 in the sixth embodiment differs from that of the object 10H2 in the first embodiment.

### <Example of Operation and Display>

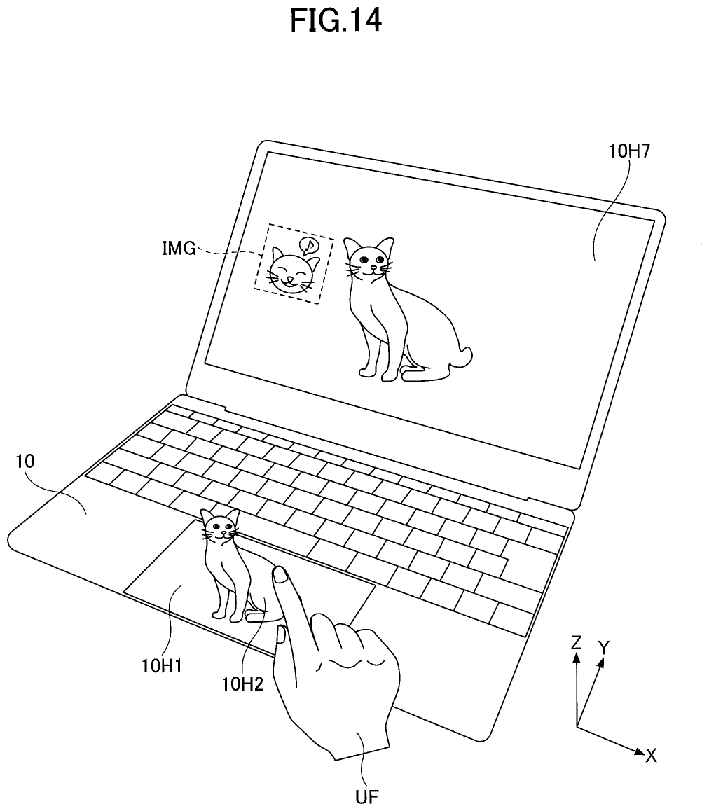

FIG. 14 is a diagram illustrating an example of the operation and display of the information processing apparatus according to the sixth embodiment. For example, as illustrated in FIG. 14, the notebook PC 10 can detect gestures such as a swipe on the object 10H2.

Even with the object 10H2 having a shape as illustrated in FIG. 14, the notebook PC 10 can determine a change in a resistance value in accordance with the movement of the user's fingertip UF, such as a swipe.

Accordingly, the notebook PC 10 can change an image (IMG) in accordance with an operation performed by the user UR, and display the changed image (IMG), as illustrated in FIG. 13 and FIG. 14.

### Seventh Embodiment

The overall configuration and the hardware configuration of an information processing apparatus according to a seventh embodiment are similar to those of the first embodiment. In the following, differences from the first embodiment will be mainly described, and a duplicate description will be omitted.

The seventh embodiment differs from the first embodiment in that a plurality of objects 10H2 are combined and placed.

### <Example of Placement of Objects>

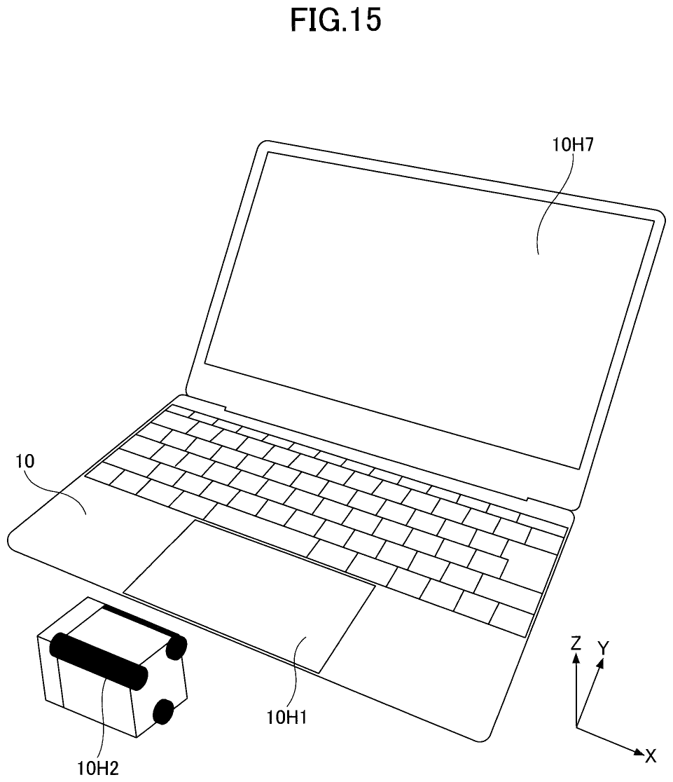

FIG. 15 is an external view of the information processing apparatus according to the seventh embodiment. As illustrated in FIG. 15, in the seventh embodiment, the plurality of objects 10H2 are combined and placed on the touchpad 10H1.

The plurality of the objects 10H2 in the seventh embodiment are formed of the same material as in the first embodiment, and are manufactured in the same manner as in the first embodiment. In the example illustrated in FIG. 15, the three objects 10H2 are placed on the touchpad 10H1.

### <Examples of Operation and Display>

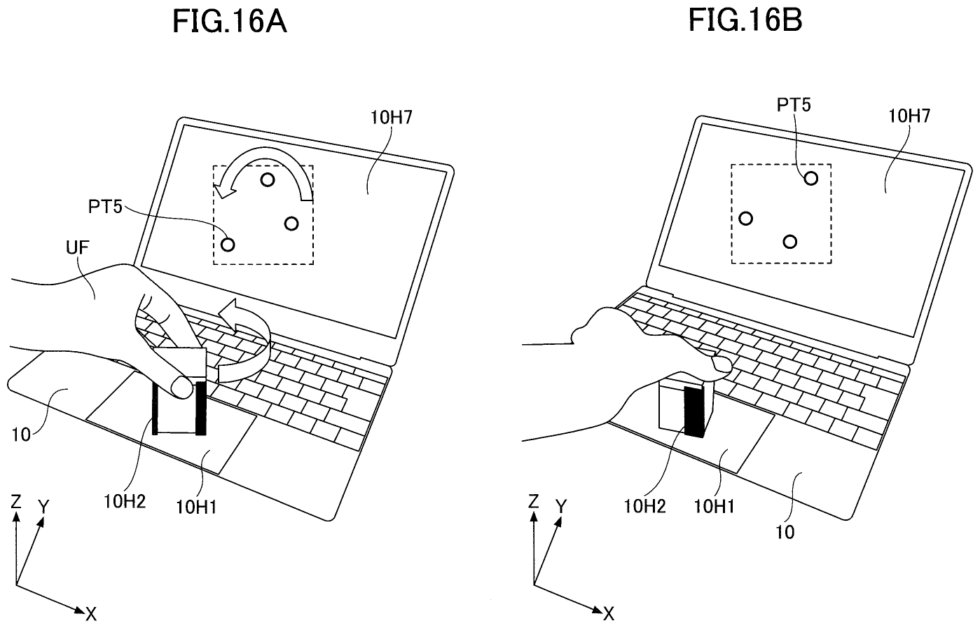

FIGS. 16A and 16B are diagrams (part 1) illustrating examples of the operation and display of the information processing apparatus according to the seventh embodiment. As illustrated in FIG. 16A, the three objects 10H2 are placed on the touchpad 10H1. As illustrated, pointers T5 corresponding to the respective objects 10H2 are displayed. In FIG. 16A, three marks indicating the pointers T5 are displayed on the screen in accordance with the respective positions of the three objects 10H2.

Specifically, for example, the user UR rotates the three objects from the positions illustrated in FIG. 16A to positions illustrated in FIG. 16B (that is, a yaw rotation around the Z-axis).

When such an operation is performed, the notebook PC 10 rotates the pointers T5 on the screen, and displays the rotated pointers T5 as illustrated in FIG. 16B.

Note that the notebook PC 10 may detect the movement of the three objects 10H2 on the touchpad 10H1 (a translation in the X-Y plane), and may move the pointers T5 on the screen.

As illustrated in FIGS. 16A and 16B, even when there are the plurality of objects 10H2, the notebook PC 10 can determine the positions of the respective objects 10H2 on the touchpad 10H1, based on electrical characteristics such as current values “i”.

Further, the above-described three objects 10H2 may be used for the following operation and display.

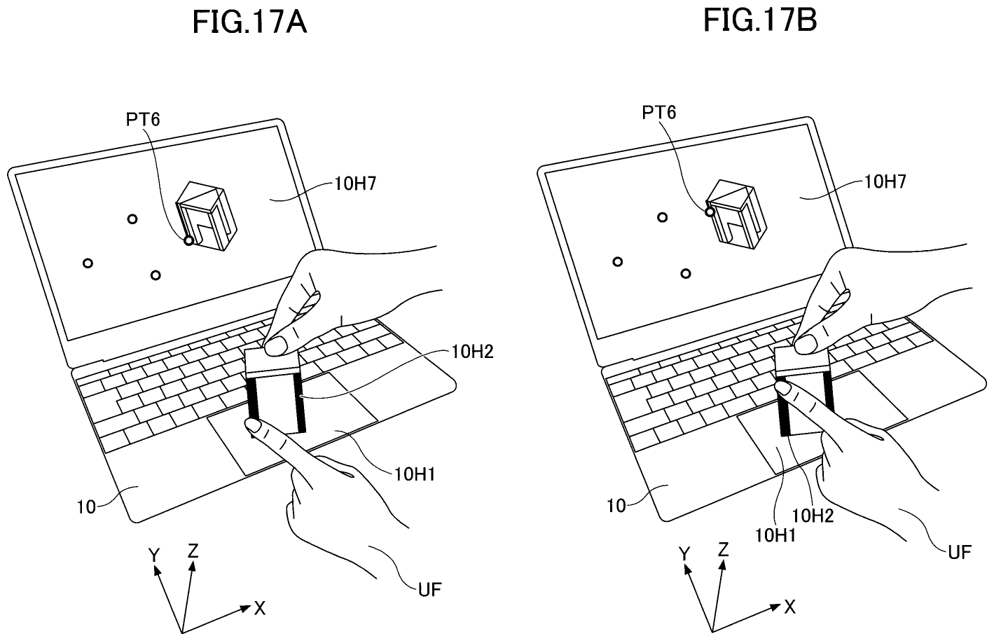

FIGS. 17A and 17B are diagrams (part 2) illustrating examples of the operation and display of the information processing apparatus according to the seventh embodiment. As in FIG. 16A and FIG. 16B, the three objects 10H2 are placed on the touchpad 10H1.

As illustrated in FIG. 17A, the user UR brings the fingertip UF into contact with a lower part of an object 10H2 of the three objects 10H2. When such an operation is performed, the notebook PC 10 displays a pointer PT6 at a lower part of an image on the screen.

Conversely, as illustrated in FIG. 17B, the user UR brings the fingertip UF into contact with an upper part of the same object 10H2. When such an operation is performed, the notebook PC 10 displays the pointer PT6 at an upper part of the image on the screen.

As illustrated in FIG. 17A and FIG. 17B, the notebook PC 10 can determine which object is operated by the user UR, among the three objects 10H2. As illustrated in FIG. 17A and FIG. 17B, when the same object 10H2 is operated by the user UR, the notebook PC 10 changes the position of the pointer PT6 displayed on the same image corresponding to the object 10H2 on the screen.

Accordingly, as illustrated in FIGS. 16A through 17B, the notebook PC 10 can change the position of the pointer PT6 in accordance with the touch position and the object being operated, and display the pointer PT6.

### Eighth Embodiment

The overall configuration and the hardware configuration of an information processing apparatus according to an eighth embodiment are similar to those of the first embodiment. In the following, differences from the first embodiment will be mainly described, and a duplicate description will be omitted.

The eighth embodiment differs from the first embodiment in that a plurality of objects 10H2 are combined and placed.

### <Example of Placement of Objects>

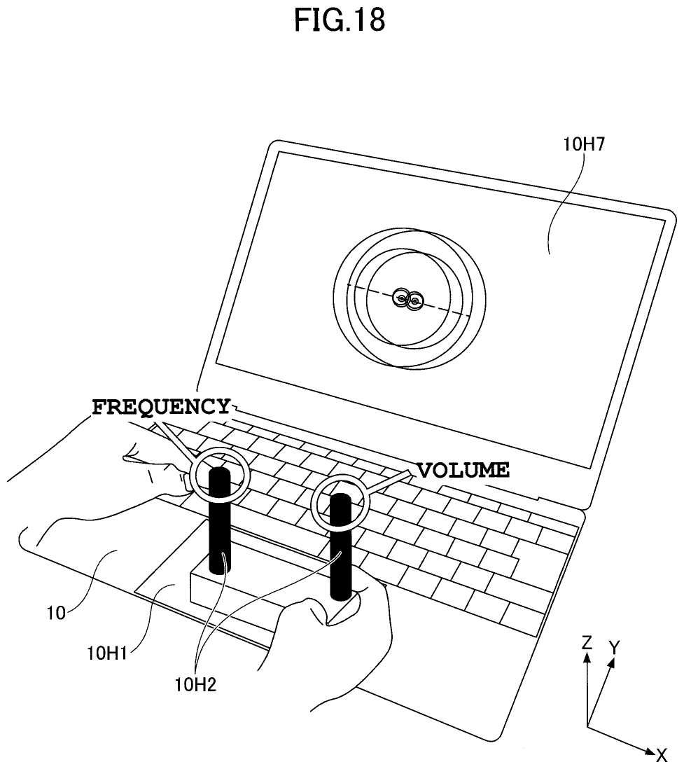

FIG. 18 is an external view of the information processing apparatus according to the eighth embodiment. As illustrated in FIG. 18, in the eighth embodiment, the plurality of objects 10H2 are combined and placed on the touchpad 10H1.

The plurality of the objects 10H2 in the eighth embodiment are formed of the same material as in the first embodiment, and are manufactured in the same manner as in the first embodiment. In the example illustrated in FIG. 18, the two objects 10H2 are placed on the touchpad 10H1.

### <Examples of Operation and Display>

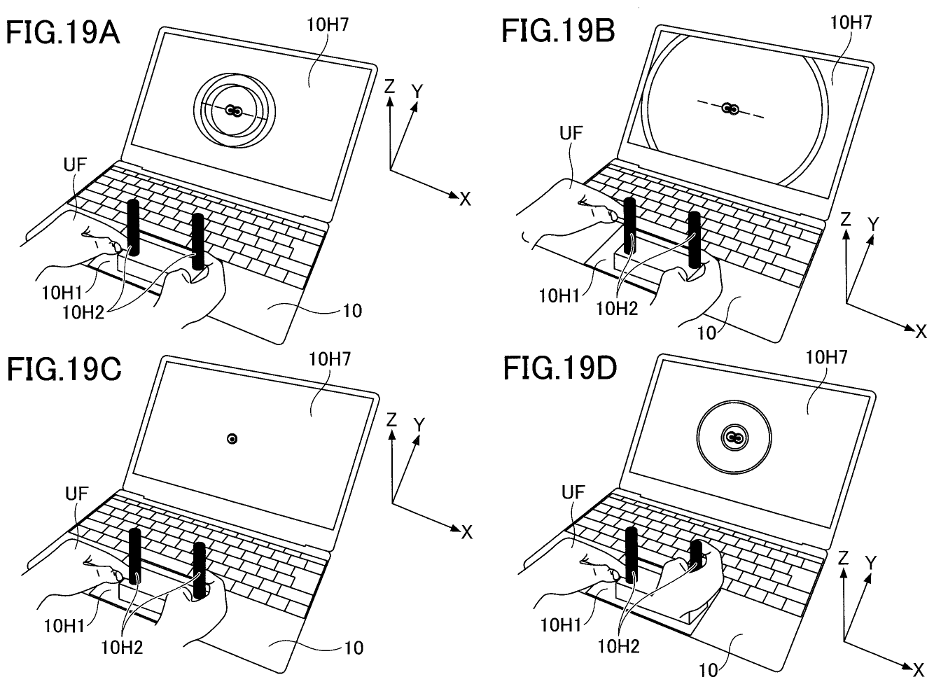

FIGS. 19A through 19D are diagrams illustrating examples of the operation and display of the information processing apparatus according to the eighth embodiment. One of the objects 10H2 is operated in FIG. 19A and FIG. 19B, and the other object 10H2 is operated in FIG. 19C and FIG. 19D. Specifically, the left object 10H2 is operated in FIG. 19A and FIG. 19B, and the right object 10H2 is operated in FIG. 19C and FIG. 19D. The left object 10H2 allows the user UR to change the frequency of a sound output from the notebook PC 10

In FIG. 19C and FIG. 19D, the right object 10H2 is operated. The right object 10H2 allows the user UR to change the volume of a sound output from the notebook PC 10.

In FIG. 19A and FIG. 19B, the same left object 10H2 is operated by the user UR, but the touch position of the fingertip UF differs. Specifically, FIG. 19A illustrates an example in which the touch position of the fingertip UF is low. FIG. 19B illustrates an example in which the touch position of the fingertip UF is high. For example, as illustrated in FIG. 19A, when the position where the fingertip UF touches the left object 10H2 is low, the notebook PC 10 outputs a low-frequency sound. Conversely, as illustrated in FIG. 19B, when the position where the fingertip UF touches the left object 10H2 is high, the notebook PC 10 outputs a high-frequency sound.

Similarly, in FIG. 19C and FIG. 19D, the same right object 10H2 is operated by the user UR, but the touch position of the fingertip UF differs. Specifically, FIG. 19C illustrates an example in which the touch position of the fingertip UF is low. FIG. 19D illustrates an example in which the touch position of the fingertip UF is high. For example, as illustrated in FIG. 19C, when the position where the fingertip UF touches the right object 10H2 is low, the notebook PC 10 outputs a low-volume sound. Conversely, as illustrated in FIG. 19D, when the position where the fingertip UF touches the right object 10H2 is high, the notebook PC 10 outputs a high-volume sound.

Accordingly, as illustrated in FIGS. 19A through 19D, the notebook PC 10 can change a parameter, which differs on a per-object basis, in accordance with the touch position and the object being operated.

### Ninth Embodiment

The overall configuration and the hardware configuration of an information processing apparatus according to a ninth embodiment are similar to those of the first embodiment. In the following, differences from the first embodiment will be mainly described, and a duplicate description will be omitted.

An object 10H2 of the ninth embodiment differs from the object 10H2 of the first embodiment.

### <Example of Placement of Object>

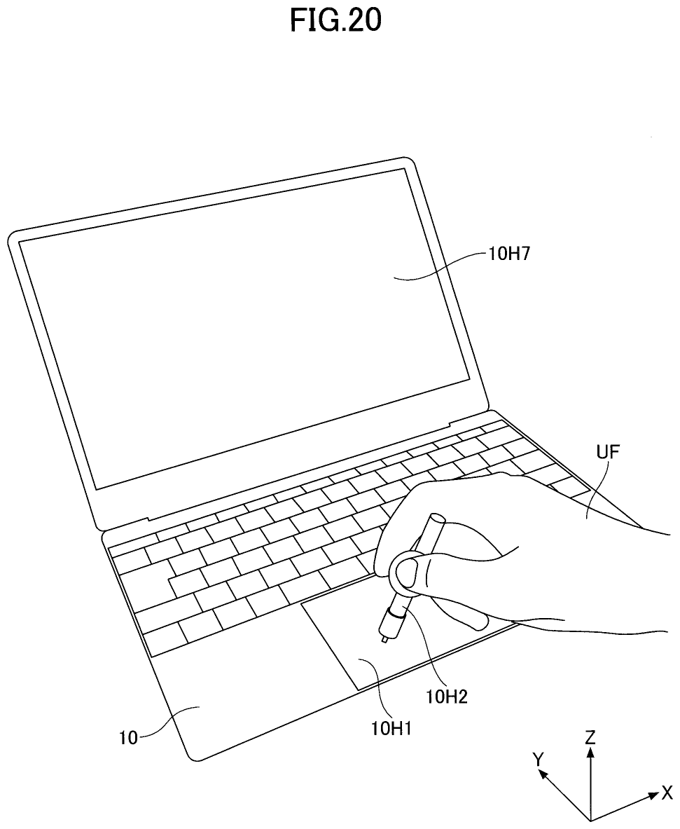

FIG. 20 is an external view of the information processing apparatus according to the ninth embodiment. As illustrated in FIG. 20, in the ninth embodiment, the object 10H2 has a pen shape, for example. The object 10H2 includes a pressure sensor, which is an example of an operating device. That is, as illustrated in FIG. 20, when the user UR presses a predetermined point of the object 10H2 with the fingertip UF, the object 10H2 can detect the pressure excreted on the predetermined point.

The object 10H2 changes the resistance value in accordance with the pressure excreted on the predetermined point. Therefore, the user UR can change the resistance value of the object 10H2 by pressing the object 10H2. For example, the resistance value of the object 10H2 can be changed in accordance with the pressure in the range of 10 kilo ohms (KΩ) to 100 KΩ.

### <Examples of Operation and Display>

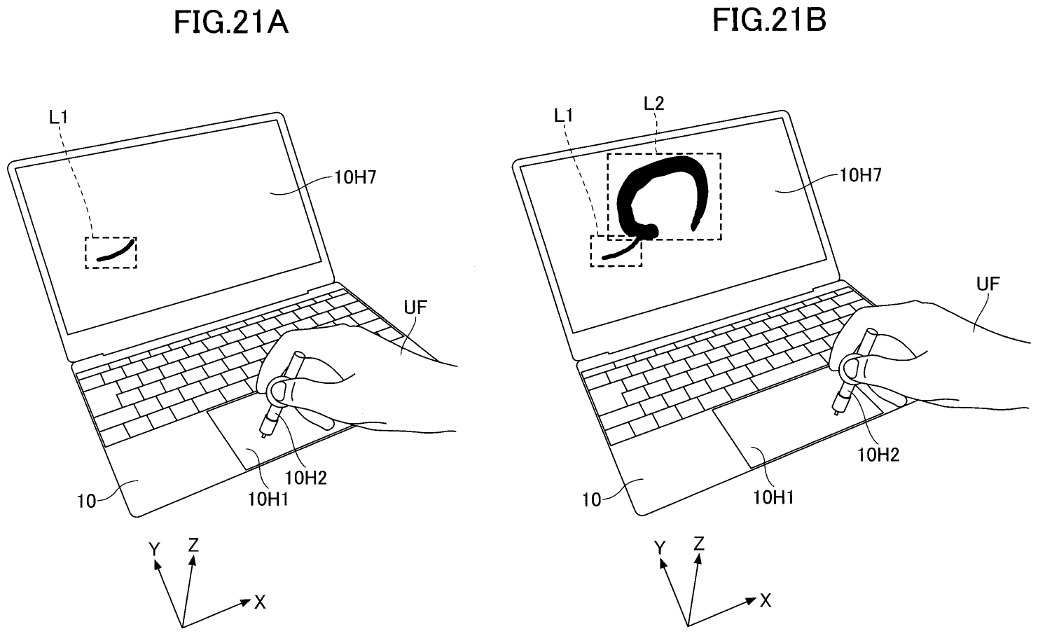

FIGS. 21A and 21B are diagrams illustrating examples of the operation and display of the information processing apparatus according to the ninth embodiment. In FIG. 21A and FIG. 21B, when the surface of the touchpad 10H1 is traced by the object 10H2, the notebook PC 10 draws a line on the screen in accordance with the position of the object 10H2. In addition, the notebook PC 10 changes the line width in accordance with the resistance value of the object 10H2.

FIG. 21A and FIG. 21B are different in terms of whether the object 10H2 is pressed by the user UR. Specifically, FIG. 21A illustrates an example in which the object 10H2 is not pressed by the fingertip UF, that is, the pressure is detected to be “low”. Conversely, FIG. 21B illustrates an example in which the object 10H2 is pressed by the fingertip UF, that is, the pressure is detected to be “high”. Therefore, the resistance value of the object 10H2 differs between FIG. 21A and FIG. 21B.

When the resistance value of the object 10H2 is low, the notebook PC 10 draws a thin line L1 on the screen as illustrated in FIG. 21A.

Conversely, when the resistance value of the object 10H2 is high, the notebook PC 10 draws a thick line L2 on the screen as illustrated in FIG. 21B. As illustrated, the thick line L2 is a line thicker than the thin line L1, and thickness of the thick line L2 differs from the thickness of the thin line L1.

The notebook PC 10 can identify the resistance value of the object 10H2 based on electrical characteristics such as a current value “i”. Accordingly, when the user UR uses the operating device to perform an operation for changing the resistance value of the object 10H2, the resistance value of the object 10H2 is changed, and the notebook PC 10 can detect the change in the resistance value of the object 10H2 based on electrical characteristics such as a current value “i”. Therefore, with the use of drawing software, the notebook PC 10 can continuously change the line width based on the user's operation for changing the resistance value of the object 10H2, as in the thin line L1 and the thick line L2 illustrated in FIG. 21A and FIG. 21.

### Tenth Embodiment

The overall configuration and the hardware configuration of an information processing apparatus according to a tenth embodiment are similar to those of the ninth embodiment. In the following, differences from the ninth embodiment will be mainly described, and a duplicate description will be omitted.

The tenth embodiment differs from the ninth embodiment in that a plurality of objects 10H2 are used. For example, in the tenth embodiment, the plurality of pen-shaped objects 10H2 are used. In addition, the plurality of objects 10H2 have respective resistance values. For example, the objects 10H2 have respective resistance values of 10 KΩ, 50 KΩ, and 100 KΩ.

Accordingly, the notebook PC 10 can determine which object 10H2 is used from the plurality of the objects 10H2, based on electrical characteristics such as a current value “i”.

### <Examples of Operation and Display>

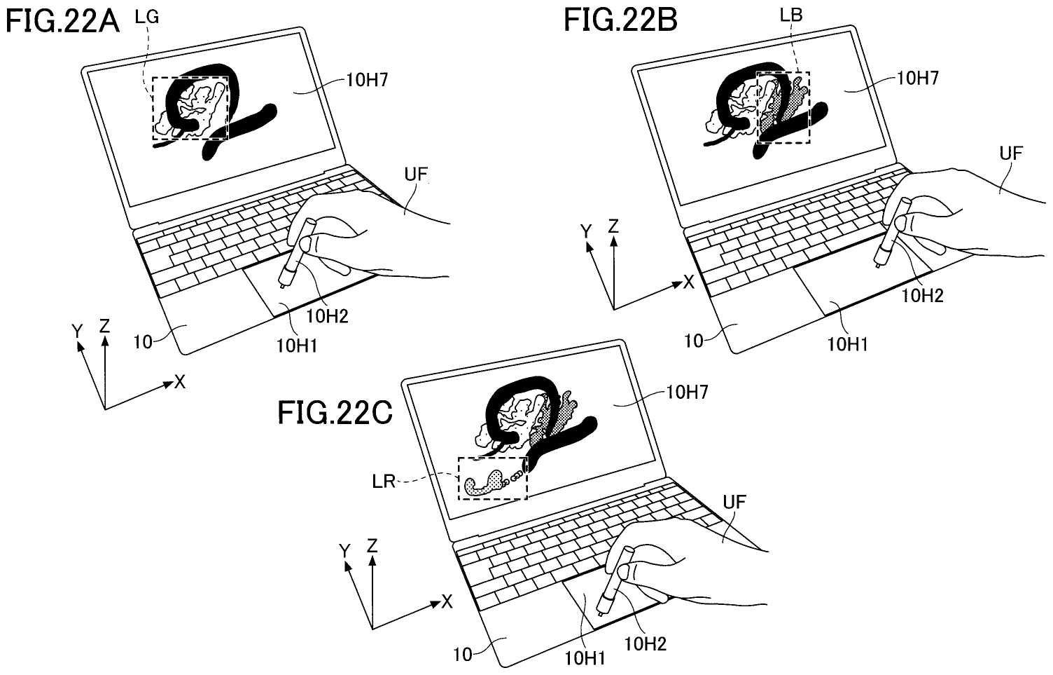

FIGS. 22A through 22C are diagrams illustrating examples of the operation and display of the information processing apparatus according to the tenth embodiment. In the examples illustrates in FIGS. 22A through 22C, the different objects 10H2 are used.

For example, in FIG. 22A, the notebook PC 10 draws a green line LG. Similarly, in FIG. 22B, the notebook PC 10 draws a blue line LB. Further, in FIG. 22C, the notebook PC 10 draws a red line LR. The notebook PC 10 displays lines of different colors, such as the green line LG, the blue line LB, and the red line LR, in accordance with the resistance values of the respective objects 10H2.

The notebook PC 10 can identify the resistance values of the respective objects 10H2 based on electrical characteristics such as current values “i”. Accordingly, with the use of drawing software, the notebook PC 10 can display different colors corresponding to the respective objects 10H2.

### Eleventh Embodiment

The overall configuration and the hardware configuration of an information processing apparatus according to an eleventh embodiment are similar to those of the ninth embodiment. In the following, differences from the ninth embodiment will be mainly described, and a duplicate description will be omitted.

An object 10H2 of the eleventh embodiment is different from the object 10H2 of the ninth embodiment.

### <Example of Object>

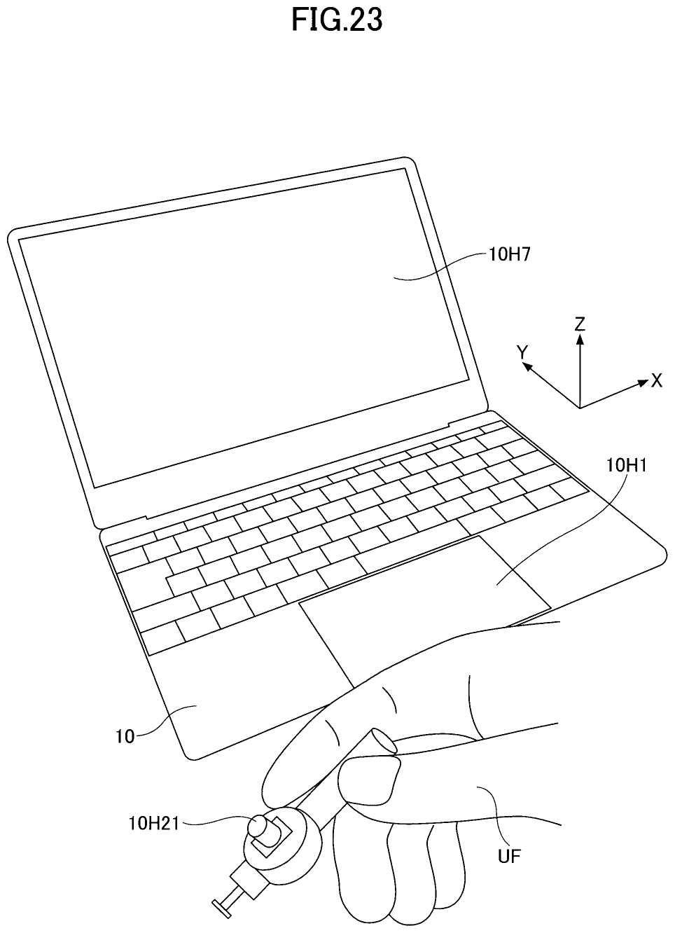

FIG. 23 is an external view of an information processing apparatus according to the eleventh embodiment. As illustrated in FIG. 23, the object 10H2 includes a potentiometer 10H21 that can change the resistance value by turning a knob. That is, the user UR uses the operating device such as the potentiometer 10H21 to perform an operation for changing the resistance value of the object 10H2. For example, the potentiometer 10H21 can change the resistance value in the range of 0 kΩ to 100 kΩ.

### <Examples of Operation and Display>

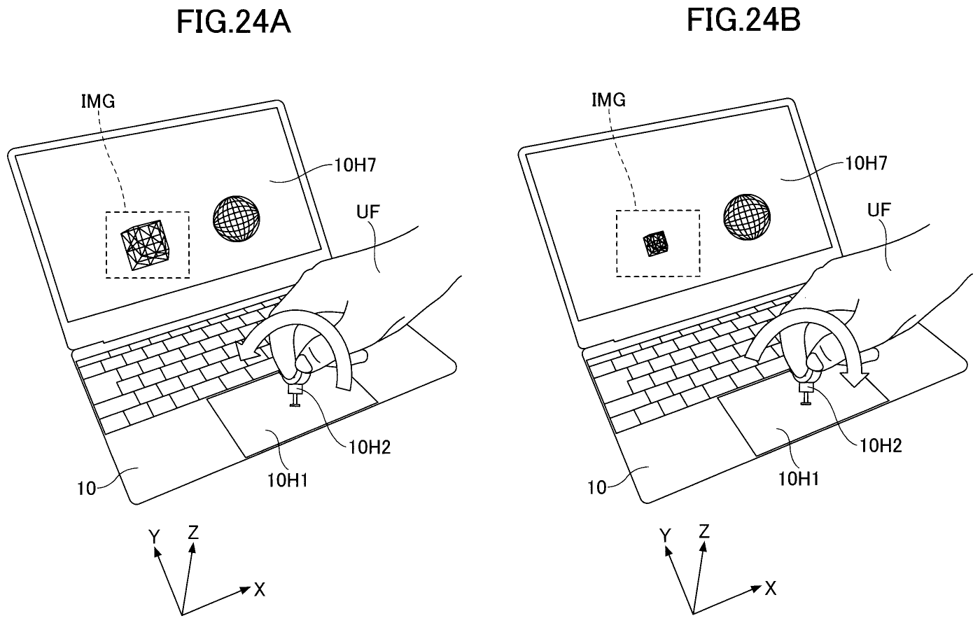

FIGS. 24A and 24B are diagrams illustrating examples of the operation and display of the information processing apparatus according to the eleventh embodiment. In FIG. 24A and FIG. 24B, the user UR rotates the knob of the potentiometer 10H21. The rotation direction of the knob in FIG. 24A differs from the rotation direction of the knob in FIG. 24B. That is, when the knob is rotated in one direction, the resistance value increases, and when the knob is rotated in the other direction, the resistance value decreases.

The notebook PC 10 changes the size of an image IMG in accordance with the resistance value, and displays the image IMG whose size is changed. For example, when an operation as illustrated in FIG. 24A is performed, the notebook PC 10 scales up an image IMG and displays the scaled-up image IMG. Conversely, when an operation as illustrated in FIG. 24B is performed, the notebook PC 10 scales down an image IMG and displays the scaled-down image IMG. Accordingly, the size of the displayed image IMG differs between FIG. 24A and FIG. 24B.

The notebook PC 10 can identify the resistance value of the object 10H2 based on electrical characteristics such as a current value “i”. Therefore, when the resistance value of the object 10H2 is changed by the user's operation, the notebook PC 10 can detect the change in the resistance value. Accordingly, the notebook PC 10 can scale up or down an image IMG in accordance with the resistance value of the object 10H2, and display the scaled-up or scaled-down image IMG.

### Twelfth Embodiment

The overall configuration and the hardware configuration of an information processing apparatus according to a twelfth embodiment are similar to those of the eleventh embodiment. In the following, differences from the eleventh embodiment will be mainly described, and a duplicate description will be omitted.

An object 10H2 of the twelfth embodiment differs from the object 10H2 of the eleventh embodiment.

### <Example of Placement of Object>

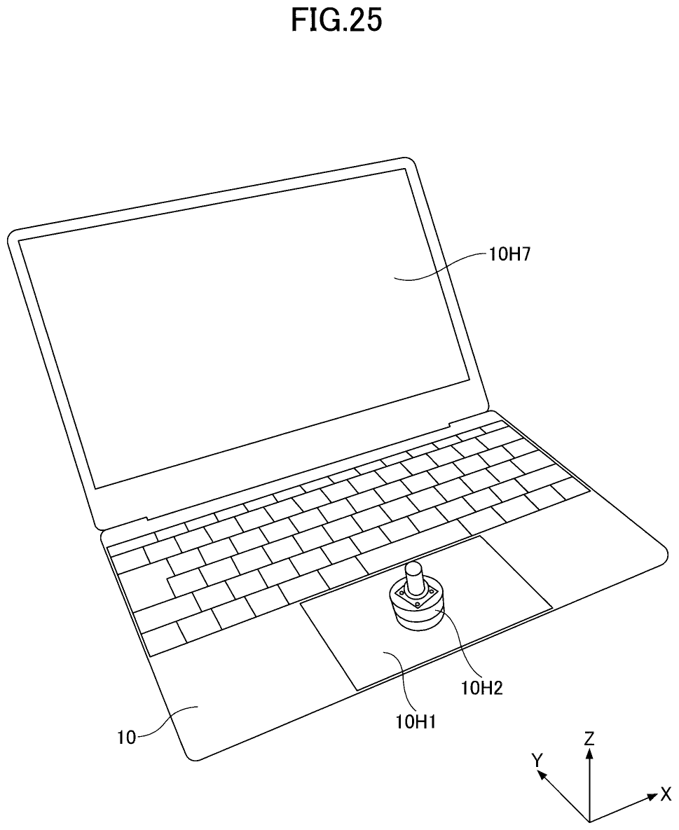

FIG. 25 is an external view of an information processing apparatus according to the twelfth embodiment. As illustrated in FIG. 25, the object 10H2 in the twelfth embodiment is a variable resistor that can change the resistance value by rotating a dial. By rotating the dial of the object 10H2, the resistance value can be changed in the range of 0 kΩ to 100 kΩ.

### <Example of Operation and Display>

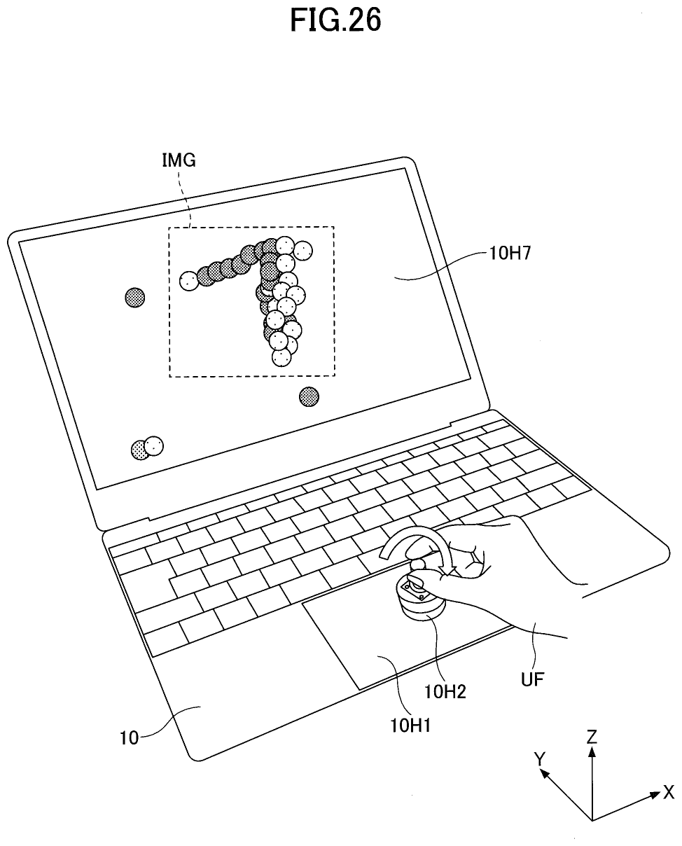

FIG. 26 is a diagram illustrating an example of the operation and display of the information processing apparatus according to the twelfth embodiment. As illustrated in FIG. 26, user UR rotates the dial of the object 10H2.

In response to a change in the resistance value of the object 10H2, the notebook PC 10 changes the transmittance (which may also be referred to as “transparency”) of an image IMG.

The notebook PC 10 can identify the resistance value of the object 10H2 based on electrical characteristics such as a current value “i”. Therefore, when the resistance value of the object 10H2 is changed by the user's operation, the notebook PC 10 can detect the change in the resistance value. Accordingly, the notebook PC 10 can change the transmittance of an image IMG in accordance with the resistance value of the object 10H2, z image IMG.

### Thirteenth Embodiment

The overall configuration and the hardware configuration of an information processing apparatus according to a thirteenth embodiment are similar to those of the first embodiment. In the following, differences from the first embodiment will be mainly described, and a duplicate description will be omitted.

An object 10H2 of the thirteenth embodiment is different from the object 10H2 of the first embodiment.

### <Example of Placement of Object>

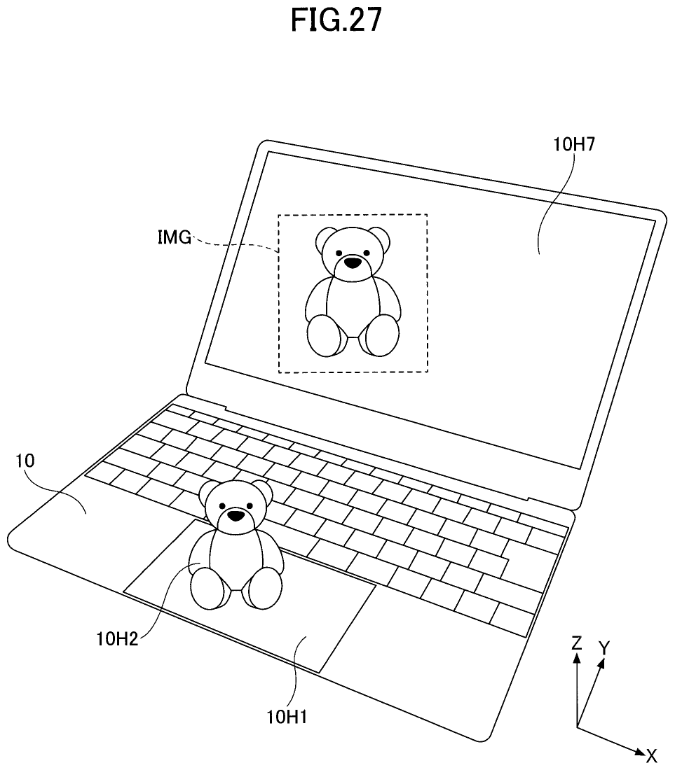

FIG. 27 is an external view of the information processing apparatus according to the thirteenth embodiment. As illustrated in FIG. 27, the object 10H2 may be provided in the form of a doll, for example. The object 10H2 has a pressure sensor. In the example illustrated in FIG. 27, the object 10H2 changes the resistance value in response to compressive force in the lateral direction (in the X-axis direction, in the example illustrated in FIG. 27). For example, the resistance value can be changed in the range of 10 kΩ to 10 mega ohms (MΩ).

### <Examples of Operation and Display>

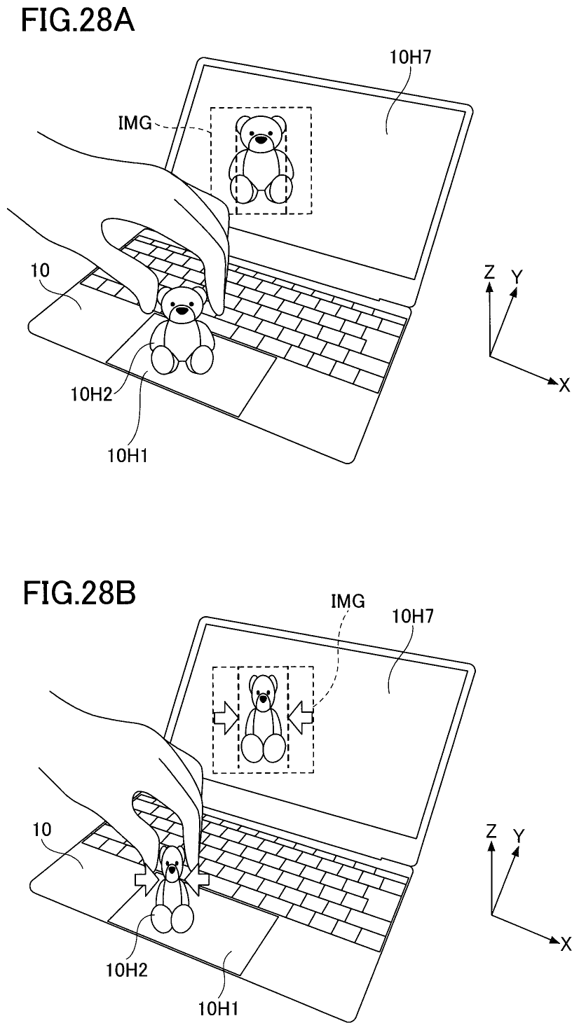

FIGS. 28A and 28B are diagrams illustrating examples of the operation and display of the information processing apparatus according to the thirteenth embodiment. FIG. 28B illustrates an example in which more compressive force is exerted on the object 10H2, as compared to the example illustrated in FIG. 28A. Accordingly, the magnitude of force differs between the example illustrated in FIG. 28A and the example illustrated in FIG. 28B. Therefore, the notebook PC 10 can identify the resistance value based on electrical characteristics such as a current value “I”.

The notebook PC 10 display image IMG in accordance with the magnitude of detected force, as illustrated in FIG. 28A and FIG. 28B. Specifically, the image IMG of the object 10H2 displayed in FIG. 28B is more squeezed than the image IMG of the object 10H2 displayed in FIG. 28A.

The notebook PC 10 can identify the resistance value of the object 10H2 based on electrical characteristics such as a current value “i”. Therefore, when the resistance value of the object 10H2 is changed by the user's operation for exerting a force on the object 10H2, the notebook PC 10 can detect the change in the resistance value. Accordingly, the notebook PC 10 can increase or decrease the width of an image IMG in accordance with the resistance value of the object 10H2, and displays the image IMG.

### Fourteenth Embodiment

The overall configuration and the hardware configuration of an information processing apparatus according to a fourteenth embodiment are similar to those of the first embodiment. In the following, differences from the first embodiment will be mainly described, and a duplicate description will be omitted.

An object 10H2 of the fourteenth embodiment is different from the object 10H2 of the first embodiment.

### <Example of Placement of Object>

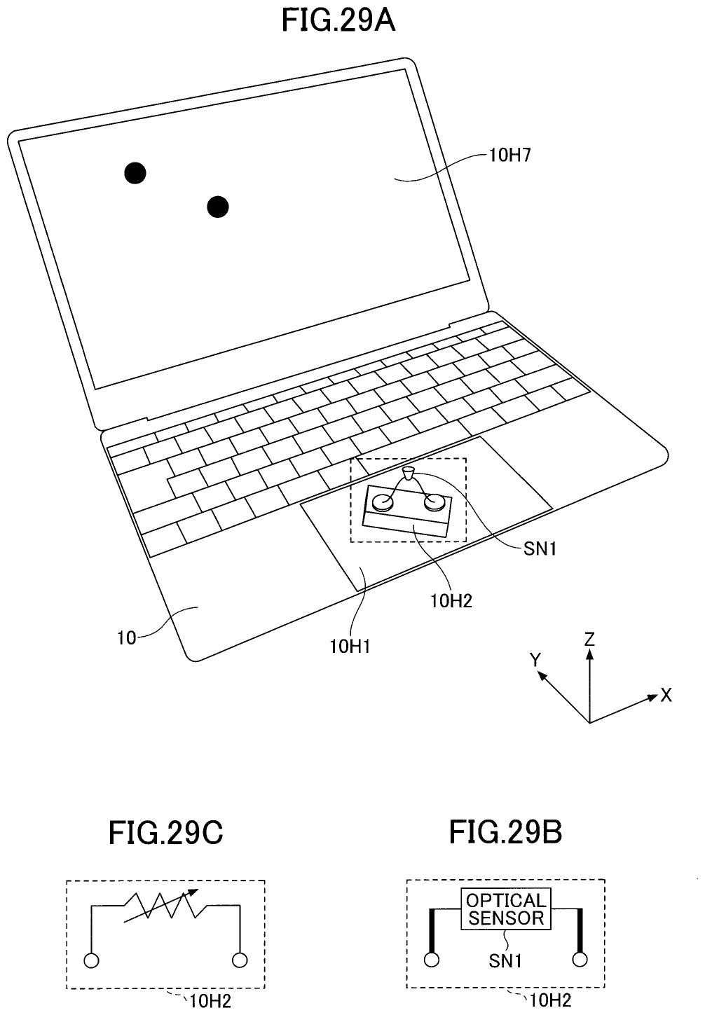

FIGS. 29A through 29C are an external view of the information processing apparatus and circuit diagrams according to the fourteenth embodiment. In the fourteenth embodiment, the object 10H2 employs the principle of PUCs (passive untouched capacitive widgets on unmodified multi-touch displays).

Specifically, PUCs are described in, for example, “S. Voelker, K. Nakajima, C. Thoresen, Y. Itoh, K. I. Øvergård, and J. Borchers. PUCs: Detecting Transparent, Passive Untouched Capacitive Widgets on Unmodified Multi-touch Displays. In Proceedings of ITS '13, pp. 101-104, 2013”. Accordingly, the object 10H2 using the principle of PUCs includes two or more touch points that are electrically connected to each other. Further, the object 10H2 is placed on the touch surface. When one touch point is active, the other touch points serve as ground. This state is equivalent to a state where a person continuously touching the touch surface.

In the example illustrated in FIG. 29A, the object 10H2 includes two touch points, is formed of the same material as in the first embodiment, and is manufactured in the same manner as in the first embodiment. The two touch points are connected via a sensor.

The above-described configuration of the object 10H2 can be represented by a schematic diagram as illustrated in FIG. 29B. In this example, an optical sensor SN1, which is an example of a measuring device and a changing device, is used. That is, the optical sensor SN1 is an example of a variable resistor sensor that measures the amount of light, and changes the resistance value based on the measured amount of light. For example, the optical sensor SN1 may be a cadmium sulfide (CdS) cell. When the above-described optical sensor SN1 is used, the resistance value can be changed in the range of 10 kΩ to 1 MΩ.

The object 10H2 can be represented by an equivalent circuit as illustrated in FIG. 29C. That is, in the fourteenth embodiment, the user UR can change the resistance value of the object 10H2 by performing an operation for changing the amount of light emitted to the object 10H2.

### <Examples of Operation and Display>

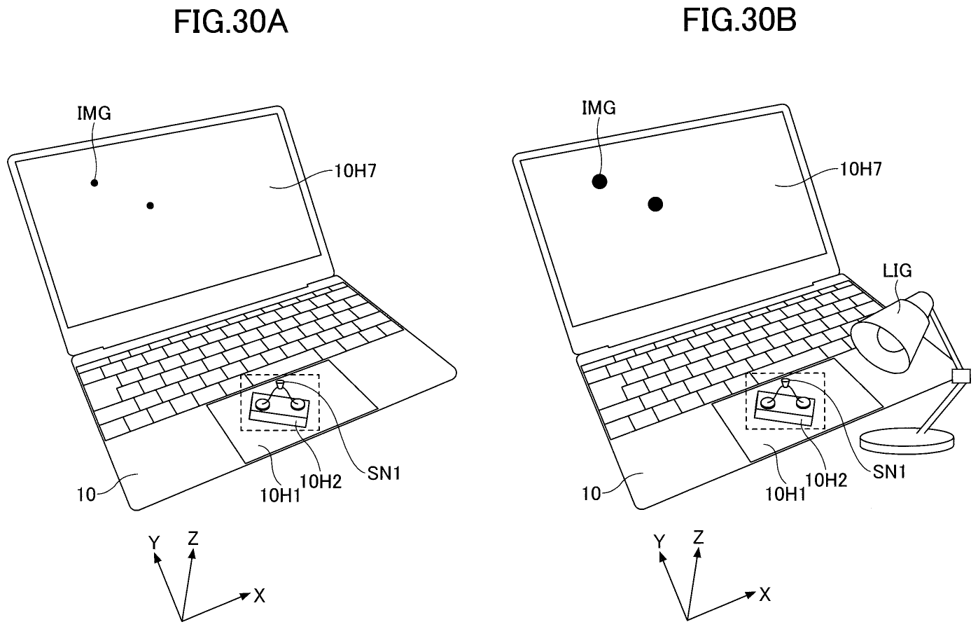

FIGS. 30A and 30B are diagrams illustrating examples of the operation and display of the information processing apparatus according to the fourteenth embodiment. The amount of light emitted to the object 10H2 differs between FIG. 30A and FIG. 30B.

Specifically, in FIG. 30B, a light source LIG emits light to the object 10H2. Therefore, the state illustrated in FIG. 30B is brighter than the state illustrated in FIG. 30A. That is, the amount of light measured in FIG. 30B is greater than the amount of light measured in FIG. 30A. Conversely in FIG. 30A, no light source LIG is provided near the object 10H2. Therefore, the state illustrated in FIG. 30A is darker than the state illustrated in FIG. 30B. That is, the amount of light measured in FIG. 30A is smaller than the amount of light measured in FIG. 30B.

Accordingly, because the measured amount of light differs between FIG. 30A and FIG. 30B, the notebook PC 10 identifies different resistance values between FIG. 30A and FIG. 30B, based on electrical characteristics such as current values “I”.

As illustrated in FIG. 30A and FIG. 30B, the notebook PC 10 displays different images IMG in accordance with the respective amounts of light measured. Specifically, an image IMG displayed in FIG. 30B is larger than an image IMG displayed in FIG. 30A.

The notebook PC 10 can identify the resistance value of the object 10H2, based on electrical characteristics such as a current value “i”. Therefore, when the resistance value of the object 10H2 is changed by the user's operation for changing a value to be measured, the notebook PC 10 can detect the change in the resistance value of the object 10H2. Accordingly, the notebook PC 10 can scale up or down an image IMG in accordance with the resistance value of the object 10H2, and display the scaled-up or scaled-down image.

### Fifteenth Embodiment

The overall configuration and the hardware configuration of an information processing apparatus according to a fifteenth embodiment are similar to those of the fifteenth embodiment. In the following, differences from the fifteenth embodiment will be mainly described, and a duplicate description will be omitted.

The fifteenth embodiment differs from the fourteenth embodiment in that a different type of sensor is used for the object 10H2.

### <Example of Placement of Object and Example of Operation and Display>

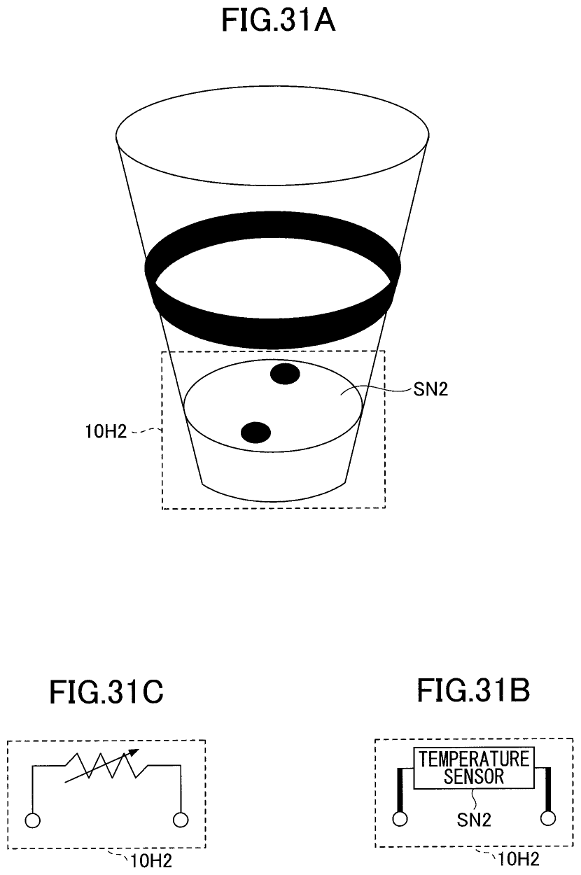

FIGS. 31A through 31C are an external view of a part of an information processing apparatus and circuit diagrams according to the fifteenth embodiment. For example, as illustrated in FIG. 31A, the object 10H2 is placed in a container such as a cup. In the fifteenth embodiment, a temperature sensor SN2 is used. In the example illustrated in FIG. 31A, the temperature sensor SN2 is placed on the bottom of the container. However, the temperature sensor SN2 may be placed anywhere in the container, as long as the temperature of a measurement object such as a liquid can be measured. Further, other principles are same as those of the fourteenth embodiment. Accordingly, the configuration of the object 10H2 in the fifteenth embodiment can be represented by a schematic diagram as illustrated in FIG. 31B.

In this example, the temperature sensor SN2, which is an example of the measuring device and the changing device, is used. That is, the temperature sensor SN2 is an example of a variable resistor sensor that measures temperature, and changes the resistance value based on the measured temperature.

The object 10H2 can be represented by an equivalent circuit as illustrated in FIG. 31C. That is, in the fifteenth embodiment, the user UR can change the resistance value of the object 10H2 by performing an operation for changing temperature. Specifically, the user UR can change the resistance value of the object 10H2 by performing an operation for changing temperature, such as pouring a high-temperature liquid into the container in which the object 10H2 is placed.

The temperature differs depending on whether a high-temperature liquid is contained in the container. Therefore, the notebook PC 10 identifies different resistance values between when a high-temperature liquid is contained in the container and when a high-temperature liquid is not contained, based on electrical characteristics such as current values “i”.

As in the fourteenth embodiment, the notebook PC 10 displays different images IMG in accordance with the measured temperatures.

The notebook PC 10 can identify the resistance value of the object 10H2 based on electrical characteristics such as a current value “i”. Therefore, when the resistance value of the object 10H2 is changed by the user's operation for changing a value to be measured, the notebook PC 10 can detect the change in the resistance value of the object 10H2. Accordingly, the notebook PC 10 can scale up or down an image IMG in accordance with the resistance value of the object 10H2, and display the scaled-up or scaled down image.

### <Example of Overall Process>

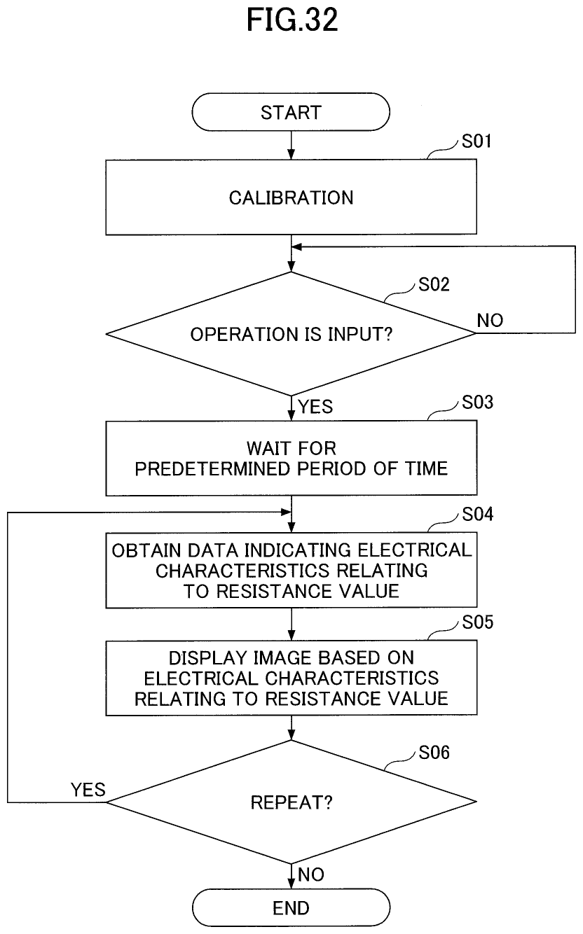

FIG. 32 is a flowchart illustrating an example of the overall process.

### <Example of Calibration (Step S01>

In step S01, an information processing apparatus performs calibration. For example, step SO1 is performed before a user performs an operation (before it is determined to be yes in step S02). That is, step S01 is desirably performed as a preparation step.

For example, as in the first embodiment, when a part of a human body touches an object, the resistance value of the object 10H2 may vary for each person. In addition, the resistance value of the object 10H2 may also vary depending on the water content and muscle mass of a human body. Therefore, it is desirable to perform calibration to preliminarily determine what level of resistance is used.

It is desirable to preliminarily determine a resistance value to be used, particularly when the absolute value of resistance is used, as compared to when a relative value is used under the same conditions. Further, it is desirable to perform calibration when the user performing an operation is changed, an object 10H2 is changed, or resistance value settings are changed.

### <Determining Whether Operation is Input (Step S02)>

In step S02, the information processing apparatus determines whether an operation is input. As described with reference to FIG. 1, when no operation is input, a current value tends not to decrease. Therefore, when a value indicating current flow between electrodes is identified beforehand, the information processing apparatus can determine whether an operation is input based on a change in the current value “i”.

When it is determined that an operation is input (yes in step S02), the information processing apparatus proceeds to step S03. Conversely, when it is determined that an operation is not input (no in step S02), the information processing apparatus repeats step S02 (waits until an operation is input).

### <Waiting for Predetermined Period of Time (Step S03>

In step S03, the information processing apparatus desirably waits for a predetermined period of time after determining that an operation is input. For example, the predetermined period of time is approximately 1 second. Note that the predetermined period of time is a preset value. For example, predetermined period of time may be set depending on whether a change in a resistance value is made based on the user's operation as in the first embodiment or based on measurement as in the fourteenth embodiment.

For example, in a case where the user performs an operation with the fingertip UF as in the first embodiment, a resistance value tends to be unstable immediately after the operation is performed. This is because the area of an object 10H2 touched by the user's fingertip UF is often small immediately after or at the moment when the fingertip UF touches the object 10H2. As the fingertip UF is pressed against the object 10H2, the area touched by the fingertip UF increases. As the area touched by the fingertip UF is changed, the resistance vale is changed accordingly. For this reason, until the touch area is determined to some extent, it is desirable for the information processing apparatus not to identifying a resistance value and to wait for the predetermined period of time after an operation is input. That is, it is desirable for the information processing apparatus not to obtain a current value “i” and to wait for the predetermined period of time.

If a resistance value is unstable, large changes may occur in a short period of time. If such a value is used, a distorted image may be displayed. Accordingly, it is desirable for the information processing apparatus to wait until the resistance value has stabilized.

### <Obtaining Data Indicating Electrical Characteristics Relating to Resistance Value (Step S04)>

In step S04, the information processing apparatus obtains data indicating electrical characteristics relating to a resistance value. For example, the information processing apparatus obtains data indicating a current value “i” from the OS. When the current value “i” is obtained, the information processing apparatus can identify a resistance value based on the current value “i”.

<Displaying Image based on Electrical Characteristics Relating to Resistance Value (step S05)>

In step S05, the information processing apparatus displays an image based on the electrical characteristics relating to the resistance value. When the current value “i” is changed, the information processing apparatus changes the image in accordance with the amount of change in the current value “i”, and displays the changed image.

As described in the above embodiments, when an operation is performed by the user UR, the current value “i”, that is, the resistance value changes. Accordingly, the information processing apparatus changes an image in accordance with the amount of operation, and displays the changed image.

### <Determining Whether to Repeat Steps (Step S06)>

In step S06, the information processing apparatus determines whether to repeat the steps, when an image is continuously changed and is displayed based on the amount of operation, the information processing apparatus repeats step S04 and step S05.

When it is determined that the steps are repeated (yes in step S06), the information processing apparatus returns to step S04. Conversely, when it is determined that the steps are not repeated (no in step S06), the information processing apparatus ends the entire process.

### <Example of Functional Configuration>

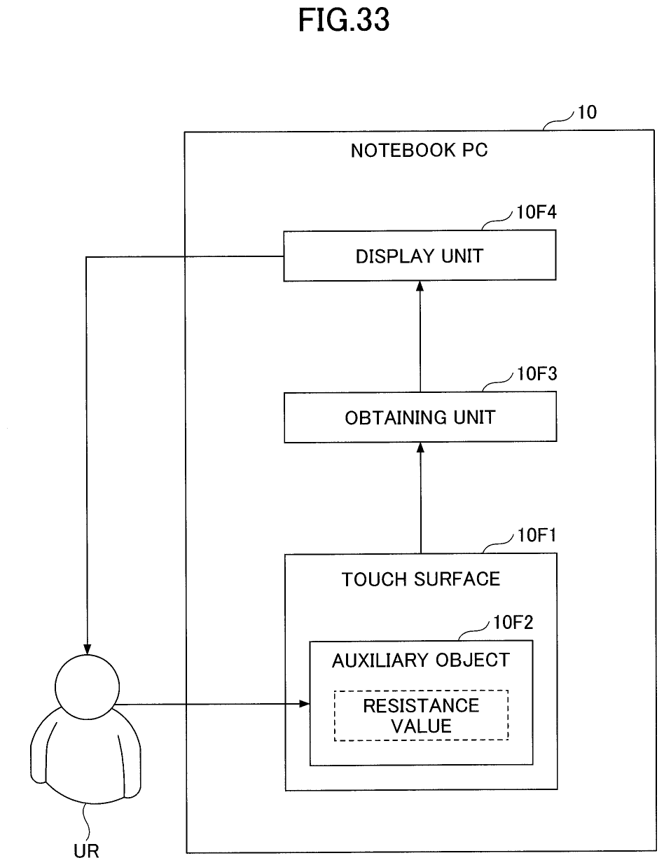

FIG. 33 is block diagram illustrating an example of the functional configuration of an information processing apparatus. As illustrated in FIG. 33, a notebook PC 10 includes a touch surface 10F1, an auxiliary object 10F2, an obtaining unit 10F3, and a display unit 10F4.

The touch surface 10F1 receives an operation from the user UR. The touch surface 10F1 is a capacitive touch surface. For example, the touch surface 10F1 may be implemented by the touchpad 10H1.

The auxiliary object 10F2 is provided in contact with the touch surface 10F1. The resistance value of the auxiliary object 10F2 changes based on a change made by the operating device, a change made by the changing device, or a change in the touch position of an electrical conductor. For example, the auxiliary object 10F2 may be implemented by the object 10H2.

The obtaining unit 10F3 performs an obtaining process for obtaining electrical characteristics relating to a resistance value. For example, the obtaining unit 10F3 is implemented by the CPU 10H3.

The display unit 10F4 performs a display process for displaying an image based on electrical characteristics obtained by the obtaining unit 10F3. For example, the display unit 10F4 is implemented by the output device 10H7.

In the first embodiment through the eighth embodiment, an operation is performed on the auxiliary object 10F2, and the resistance value of the auxiliary object 10F2 is changed in response to a change in the position where the electrical conductor touches the auxiliary object 10F2. Because the notebook PC 10 can detect the change in the resistance value based on electrical characteristics obtained by the obtaining unit 10F3, the notebook PC 10 can detect a change in the touch position of the electrical conductor. Therefore, the notebook PC 10 can cause the display unit 10F4 to display an image based on the touch position of the electrical conductor.

Further, in the ninth embodiment through the thirteenth embodiment, when the auxiliary object 10F2 includes the operating device, such as a dial or a pressure sensor, the user UR can change the resistance value by performing an operation with respect to the operating device. Because the notebook PC 10 can detect the change in the resistance value based on electrical characteristics obtained by the obtaining unit 10F3, the notebook PC 10 can detect changes in the touch position of the electrical conductor. Therefore, the notebook PC 10 can cause the display unit 10F4 to display an image based on the amount of operation.

Further, in the fourteenth embodiment and the fifteenth embodiment, the auxiliary object 10F2 includes the measuring device that measures a physical quantity to obtain a measured value, and also includes the changing device that changes a resistance value based on the measured value. In this case, when the measured value, such as the amount of light or temperature, is changed, the notebook PC 10 can detect the change in the measured value based on electrical characteristics obtained by the obtaining unit 10F3. Therefore, the notebook PC 10 can cause the display unit 10F4 to display an image based on the measured value.

Resistance values can be readily set by electronic components. Further, sensors may be used to readily set and control resistance values. In addition, the sensors are inexpensive in most cases. Further, as in the first embodiment, objects with different resistive distributions can be readily manufactured by a 3D printer. With such an object, the information processing apparatus can use continuous values to extend the range in which an operation can be received. Further, when an object has a shape as in the third embodiment, the information processing apparatus can receive an operation in the vertical direction (the Z-axis direction in the figure).

In particular, resistance values used in the above-described embodiments can be readily set by various inexpensive components, as compared to when capacitance is used, as described as in Non-Patent Document 1. In order to change capacitance, capacitors are often used. In comparison to the capacitors, resistor components allow a wide range of values to be set. In addition, as compared to the capacitors, the resistor components are smaller and cost less.

Furthermore, components used to change resistance values are more accurate and less expensive than components used to change capacitance values. There are also various types of sensors for resistance, which are less expensive than those for capacitance. Therefore, resistance values can be readily changed as compared to capacitance values.

### <Variations>

In each of the embodiments, a resistance value and the range in which the resistance value can be changed may be appropriately set depending on the settings or the type of an object.

For example, in the ninth embodiment to the twelfth embodiment, parameters other than the size, the transmittance, the shape, the line width, and the color of an image may be changed. That is, any types of parameters may be preset.

Further, in the fourteenth embodiment and the fifteenth embodiment, the values measured by the sensors are not limited to the amount of light and the temperature. That is, other kinds of physical quantities measurable by sensors may be used as the measured values. For example, a water level, pressure, or the volume of a sound may be used as the measured value. A sensor may be selected in accordance with the type of measurement. For example, when a carbon microphone is used as a sensor, the resistance value may be changed in accordance with the volume of a sound.

### Other Embodiments

For example, the configurations as described in the fourteenth embodiment and fifteenth embodiment facilitate the understanding of the functions of electronic components and sensors. Accordingly, the configurations as described in the fourteenth embodiment and fifteenth embodiment may be used for educational purposes, such as programming training.

The configurations of the apparatuses are not limited to the illustrated configurations. That is, each of the apparatuses may be a system implemented by a plurality of apparatuses. For example, two information processing apparatuses may perform a process in a distributed, parallel, or redundant manner.

All or part of a process according to the present invention may be described in a low-level language such as an assembler, or a high-level language such as an object-oriented language, and may be implemented by a program for causing a computer to execute an information processing method. That is, the program is a computer program for causing the computer, such as an information processing apparatus or an information processing system including a plurality of information processing apparatuses, to execute a process.

Accordingly, when the information processing method is executed based on the program, an arithmetic device and a controller included in the computer perform calculations and control based on the program to execute a process. A storage device included in the computer stores data used for the process, based on the program.

The program may be recorded on a computer-readable recording medium, and may be distributed. The recording medium is a medium such as an auxiliary storage device, a magnetic tape, a flash memory, an optical disc, a magneto-optical disc, or a magnetic disk. In addition, the program may be distributed over an electric communication line.

Further, although specific embodiments have been described above, the present invention is not limited to the above-described embodiments. Various variations and modifications may be made to the described subject matter without departing from the scope of the present invention.

What is claimed is:

1. An information processing apparatus comprising:
a capacitive touch surface configured to receive an operation;
an auxiliary object provided in contact with the touch surface and whose resistance value is changed;
a memory; and
a processor coupled to the memory and configured to
obtain an electrical characteristic relating to the resistance value detected by the touch surface, and
display data based on the electrical characteristic.

2. The information processing apparatus according to claim 1, wherein the auxiliary object includes an electrically conductive material, and the resistance value is changed based on a position where a grounded electrical conductor touches the electrically conductive material.

3. The information processing apparatus according to claim 1, wherein the auxiliary object includes an operating device configured to change the resistance value.

4. The information processing apparatus according to claim 3, wherein the data includes image data, text data, and sound data, and the processor changes any of a color, a thickness, transmittance, a size, and a shape of the data and displays the data, in response to the resistance value being changed by the operating device.

5. The information processing apparatus according to claim 1, wherein the auxiliary object includes
a measuring device configured to measure a value indicating any of temperature, pressure, an amount of light, and a volume of a sound, and
a changing device configured to change the resistance value based on the measured value.

6. An information processing method performed by an information processing apparatus including a capacitive touch surface configured to receive an operation; and an auxiliary object provided in contact with the touch surface and whose resistance value is changed, the method comprising:
obtaining an electrical characteristic relating to the resistance value detected by the touch surface, and
displaying data based on the electrical characteristic.

7. A non-transitory recording medium storing a program for causing a computer, including a capacitive touch surface configured to receive an operation; and an auxiliary object provided in contact with the touch surface and whose resistance value is changed, to execute an information processing method comprising:
obtaining an electrical characteristic relating to the resistance value detected by the touch surface, and
displaying data based on the electrical characteristic.
